(19) United States
(12) Patent Application Publication
(10) Pub. No.: US 2026/0110912 A1
(43) Pub. Date: Apr. 23, 2026

(54) LIGHT ABSORPTION ANISOTROPIC FILM, LAMINATE, OPTICAL DEVICE, AND HEAD-MOUNTED DISPLAY

(71) Applicant: FUJIFILM Corporation, Tokyo (JP)

(72) Inventors: Shinichi YOSHINARI, Minamiashigara-shi (JP); Naoki KOITO, Minamiashigara-shi (JP); Naoya NISHIMURA, Minamiashigara-shi (JP)

(73) Assignee: FUJIFILM Corporation, Tokyo (JP)

(21) Appl. No.: 19/426,106

(22) Filed: Dec. 19, 2025

Related U.S. Application Data
(63) Continuation of application No. PCT/JP2024/021066, filed on Jun. 10, 2024.

(30) Foreign Application Priority Data
Jul. 26, 2023 (JP) 2023-121521

(51) Int. Cl. G02B 27/01; G02F 1/00; G02F 1/13; G02F 1/1335; G02F 1/1337

(52) U.S. Cl. CPC G02B 27/0172; G02F 1/0063; G02F 1/1313; G02F 1/133504; G02F 1/133703; G02F 2202/022

(57) ABSTRACT

An object of the present invention is to provide a light absorption anisotropic film having a curved surface portion, in which a variation in film thickness and occurrence of cracks are suppressed. A light absorption anisotropic film according to the present invention is a light absorption anisotropic film having a curved surface, in which the light absorption anisotropic film is a film obtained by fixing an alignment state of a liquid crystal composition containing a liquid crystal compound, a dichroic substance, and a compound having a thiol group, and an angle θ between a transmittance central axis of the light absorption anisotropic film and a normal direction of a surface of the light absorption anisotropic film is 0° or more and 45° or less.

### CROSS-REFERENCE TO RELATED APPLICATIONS

This application is a Continuation of PCT International Application No. PCT/JP2024/021066, filed on Jun. 10, 2024, which claims priority under 35 U.S.C. § 119(a) to Japanese Patent Application No. 2023-121521, filed on Jul. 26, 2023. The above applications are hereby expressly incorporated by reference, in their entirety, into the present application.

### BACKGROUND OF THE INVENTION

### 1. Field of the Invention

The present invention relates to a light absorption anisotropic film, a laminate, an optical device, and a head-mounted display.

### 2. Description of the Related Art

An image display apparatus such as a liquid crystal display device and an organic electroluminescence (hereinafter, abbreviated as “EL”) display device is widely used as a display of a smartphone, a notebook computer, or the like. In recent years, since these devices have been thinner and lighter and are thus easily carried, the devices are used in public places, for example, transportation facilities such as trains and aircraft, libraries, and restaurants in many cases. Therefore, due to the need to protect personal information, confidential information, and the like, there is a demand for a technique for preventing the display contents of image display apparatus from being peeped by others.

For example, WO2021/246441A discloses an optical film including a light absorption anisotropic layer in which an angle θ between a transmittance central axis and a normal direction of a layer surface is 0° to 45° (claim 1), and a tint adjustment layer containing at least one organic coloring agent compound, and shows that the optical film has curvature processing suitability ([0253]).

### SUMMARY OF THE INVENTION

As a result of studying the optical film disclosed in WO2021/246441A, the present inventors have found that, in a case where a curved surface portion is provided in the light absorption anisotropic layer, there is a case where a variation in film thickness or cracks occur, and thus there is room for improvement in the curvature processing suitability.

Therefore, an object of the present invention is to provide a light absorption anisotropic film having a curved surface portion, in which a variation in film thickness and occurrence of cracks are suppressed.

Another object of the present invention is to provide a laminate, an optical device, and a head-mounted display, each of which includes the light absorption anisotropic film.

As a result of intensive studies to achieve the above object, the present inventors have found that a light absorption anisotropic film formed by immobilizing an alignment state of a liquid crystal composition containing a liquid crystal compound, a dichroic substance, and a compound having a thiol group can suppress a variation in film thickness and occurrence of cracks, and have completed the present invention.

That is, the present inventors have found that the above-described object can be achieved by employing the following configurations.
[1]A light absorption anisotropic film having a curved surface, in which the light absorption anisotropic film is a film obtained by fixing an alignment state of a liquid crystal composition containing a liquid crystal compound, a dichroic substance, and a compound having a thiol group, and an angle θ between a transmittance central axis of the light absorption anisotropic film and a normal direction of a surface of the light absorption anisotropic film is 0° or more and 45° or less.
[2] The light absorption anisotropic film according to [1], in which the compound having the thiol group is a compound having 2 or more primary or secondary thiol groups in one molecule.
[3] The light absorption anisotropic film according to [1] or [2], in which at least one of the thiol groups is the secondary thiol group.
[4] The light absorption anisotropic film according to any one of [1] to [3], in which a thiol equivalent of the compound having the thiol group is 200 or less.
[5] The light absorption anisotropic film according to any one of [1] to [4], in which a content of the compound having the thiol group is 5% to 15% by mass with respect to a total mass of the light absorption anisotropic film.
[6] The light absorption anisotropic film according to any one of [1] to [5], in which a curved surface shape in the curved surface portion is lens-shaped.
[7] The light absorption anisotropic film according to any one of [1] to [6], in which a minimum curvature radius in the curved surface portion is 20 to 300 mm.
[8] The light absorption anisotropic film according to any one of [1] to [7], in which the dichroic substance is a mixture containing at least a coloring agent compound having a maximal absorption wavelength in a wavelength range of 380 nm or more and less than 455 nm, a coloring agent compound having a maximal absorption wavelength in a wavelength range of 455 nm or more and less than 560 nm, and a coloring agent compound having a maximal absorption wavelength in a wavelength range of 560 nm or more and 700 nm or less.
[9] The light absorption anisotropic film according to any one of [1] to [8], in which a content of the dichroic substance contained in the light absorption anisotropic film is 20 to 650 mg/cm³.
[10] The light absorption anisotropic film according to any one of [1] to [9], in which an alignment degree of the light absorption anisotropic film at a wavelength of 550 nm is 0.94 or more.
[11] The light absorption anisotropic film according to any one of [1] to [10], in which a difference in alignment degree of the light absorption anisotropic film at wavelengths of 450 nm, 550 nm, and 650 nm is 0.025 or less.
[12] The light absorption anisotropic film according to any one of [1] to [11], in which a haze value of the light absorption anisotropic film is 0.3% or less.
[13]A laminate comprising: the light absorption anisotropic film according to any one of [1] to [12].
[14] An optical device comprising: the light absorption anisotropic film according to any one of [1] to [12], and a light guide plate in which a diffraction element is disposed on a surface.
[15]A head-mounted display comprising: the optical device according to [14], and an image display element.

According to the present invention, it is possible to provide a light absorption anisotropic film having a curved surface portion, in which a variation in film thickness and occurrence of cracks are suppressed.

In addition, according to the present invention, it is possible to provide a laminate, an optical device, and a head-mounted display, each of which includes the light absorption anisotropic film.

### BRIEF DESCRIPTION OF THE DRAWINGS

FIG. 1 is a top view showing an example of a light absorption anisotropic film according to the embodiment of the present invention.

FIG. 2 is a cross-sectional view taken along line A-A in FIG. 1.

### DESCRIPTION OF THE PREFERRED EMBODIMENTS

Hereinafter, the present invention will be described in detail.

The description of configuration requirements described below may be made based on typical embodiments of the present invention, but the present invention is not limited to such embodiments.

In the present specification, a numerical range expressed using “to” means a range including numerical values before and after “to” as a lower limit value and an upper limit value.

In addition, in the present specification, an upper limit value or a lower limit value described in a certain numerical range in a numerical range described in a stepwise manner may be replaced with an upper limit value or a lower limit value in another numerical range described in a stepwise manner. In addition, regarding the numerical range described in the present specification, an upper limit value or a lower limit value described in a numerical value may be replaced with a value described in Examples.

In addition, in the present specification, the terms parallel and orthogonal do not mean only strict parallel and strict orthogonal, respectively, but rather a range of parallel ±5° and a range of orthogonal ±5°, respectively.

In addition, in the present specification, as each component, a substance corresponding to each component may be used alone, or two or more kinds of substances may be used in combination. Here, in a case where two or more kinds of substances are used in combination for each component, the content of the component refers to a total content of the substances used in combination unless otherwise specified.

In addition, in the present specification, “(meth)acrylate” represents “acrylate” or “methacrylate”, “(meth)acryl” represents “acryl” or “methacryl”, and “(meth)acryloyl” represents “acryloyl” or “methacryloyl”.

In the present specification, Re(λ) and Rth(λ) represent an in-plane retardation and a thickness-direction retardation at a wavelength λ, respectively. Unless otherwise specified, the wavelength λ is 550 nm.

In the present invention, Re(λ) and Rth(λ) are values measured at the wavelength of λ in AxoScan (manufactured by Axometrics, Inc.). By inputting an average refractive index ((nx+ny+nz)/3) and a film thickness (d (μm)) in AxoScan,
a slow axis direction (°),

$$Re ( λ ) = R 0 ( λ ) , and$$

$$Rth ( λ ) = ( ( nx + ny ) / 2 - nz ) \times d$$

are calculated.
R0(λ) is expressed as a numerical value calculated by AxoScan and represents Re(λ).

In the present specification, the refractive indices nx, ny, and nz are measured using an Abbe refractometer (NAR-4T, manufactured by Atago Co., Ltd.) and a sodium lamp (λ=589 nm) as a light source. In addition, in the measurement of wavelength dependence, it can be measured with a multi-wavelength Abbe refractometer DR-M2 (manufactured by Atago Co., Ltd.) in combination with a dichroic filter.

In addition, values in Polymer Handbook (John Wiley & Sons, Inc.) and catalogs of various optical films can be used. Examples of values of the average refractive indices of main optical films are as follows: cellulose acylate (1.48), cycloolefin polymer (1.52), polycarbonate (1.59), polymethylmethacrylate (1.49), and polystyrene (1.59).

### [Light Absorption Anisotropic Film]

The light absorption anisotropic film according to the present invention has a curved surface portion.

In addition, the light absorption anisotropic film according to the present invention is a film formed by immobilizing an alignment state of a liquid crystal composition containing a liquid crystal compound, a dichroic substance, and a compound having a thiol group.

In addition, the light absorption anisotropic film according to the present invention is a film in which an angle θ (hereinafter, also abbreviated as “transmittance central axis angle θ”) between a transmittance central axis of the light absorption anisotropic film and a normal direction of a surface of the light absorption anisotropic film is 0° or more and 45° or less.

Here, the transmittance central axis of the light absorption anisotropic film means a direction in which the highest transmittance is exhibited in a case where the transmittance is measured by changing the inclination angle (polar angle) and the inclination direction (azimuthal angle) with respect to the normal direction of the surface of the light absorption anisotropic film.

Specifically, the Mueller matrix at a wavelength of 550 nm is measured using AxoScan (OPMF-2, manufactured by Axometrics, Inc.). More specifically, in the measurement, the azimuthal angle at which the transmittance central axis is inclined is first searched for, the Mueller matrix at a wavelength of 550 nm is measured while the polar angle which is the angle with respect to the surface of the light absorption anisotropic film in the normal direction is changed from −70° to 700 at intervals of 10 in the surface (the plane which has the transmittance central axis and is orthogonal to the film surface) having the normal direction of the light absorption anisotropic film along the azimuthal angle thereof, and the transmittance of the light absorption anisotropic film is derived. As a result, the direction in which the highest transmittance is exhibited is defined as the transmittance central axis.

The transmittance central axis denotes a direction of an absorption axis (major axis direction of a molecule) of the dichroic substance contained in the light absorption anisotropic film.

In addition, with respect to the normal direction of the surface of the light absorption anisotropic film, the normal direction of the surface of the light absorption anisotropic film in the curved surface portion means a normal direction of a tangent plane in contact with the curved surface of the light absorption anisotropic film, that is, the thickness direction of the light absorption anisotropic film.

In the present invention, as described above, the light absorption anisotropic film formed by immobilizing the alignment state of the liquid crystal composition containing the liquid crystal compound, the dichroic substance, and the compound having a thiol group can suppress a variation in film thickness and occurrence of cracks.

The reason why this effect is exhibited is not clear in detail, but the present inventors have presumed as follows.

First, it is considered that the compound having a thiol group contained in the liquid crystal composition functions as a so-called chain transfer agent that causes a thiol-ene reaction with a polymerizable group (for example, a terminal double bond) in other components. Therefore, it is considered that the curing reaction proceeds uniformly to the deep portion of the light absorption anisotropic film, the followability of the curved surface portion of the light absorption anisotropic film is improved, and the variation in film thickness and the occurrence of cracks are suppressed.

In addition, it is considered that the light absorption anisotropic film cured by the above-described thiol-ene reaction has a low volume shrinkage rate, and thus the residual stress remaining in the light absorption anisotropic film is small, and the number of weak portions that may be a starting point of film breakage in a case of deforming the light absorption anisotropic film is small. Therefore, it is considered that the followability of the curved surface portion of the light absorption anisotropic film is improved, and the variation in film thickness and the occurrence of cracks are suppressed.

### [Curved Surface Portion]

The light absorption anisotropic film according to the embodiment of the present invention has a curved surface portion.

Here, the curved surface portion means a portion having a curved surface shape.

In addition, the curved surface shape means a shape having a curvature of more than 0, and includes a curved surface shape which is a developable surface and a three-dimensional curved surface shape.

The developable surface means a surface which can be developed on a plane without expanding and contracting each portion of the surface, and examples of the curved surface shape which is a developable surface include surfaces corresponding to a cylindrical peripheral surface, an elliptical cylindrical peripheral surface, a conical peripheral surface, an elliptical conical peripheral surface, and the like; and the curved surface shape may be a convex curved surface or a concave curved surface.

The three-dimensional curved surface is a curved surface which cannot be produced by deformation of a plane, that is, a curved surface which is not developable, and examples thereof include surfaces corresponding to a spherical surface, a rotational ellipsoid surface, and surfaces where the cross-section forms a parabola or hyperbola (for example, a rotational parabolic surface). The three-dimensional curved shape may be a convex curved surface or a concave curved surface.

In the present invention, from the reason that the usefulness of the light absorption anisotropic film according to the present invention is further increased in a case of being used for an application of cutting unnecessary stray light incident from an oblique direction and preventing ghost images, color unevenness, and the like due to the presence of the stray light, the curved surface shape of the curved surface portion is preferably lens-shaped.

Examples of the lens-like curved surface shape include a spherical surface shape and a rotational ellipsoid surface shape, the lens-like curved surface shape, an aspherical shape and may be a convex lens-like shape or a concave lens-like shape.

In addition, in the present invention, from the reason that an effect particularly useful in a case of being applied to AR glass or the like is easily obtained, the minimum curvature radius of the curved surface portion is preferably 20 to 300 mm and more preferably 30 to 150 mm.

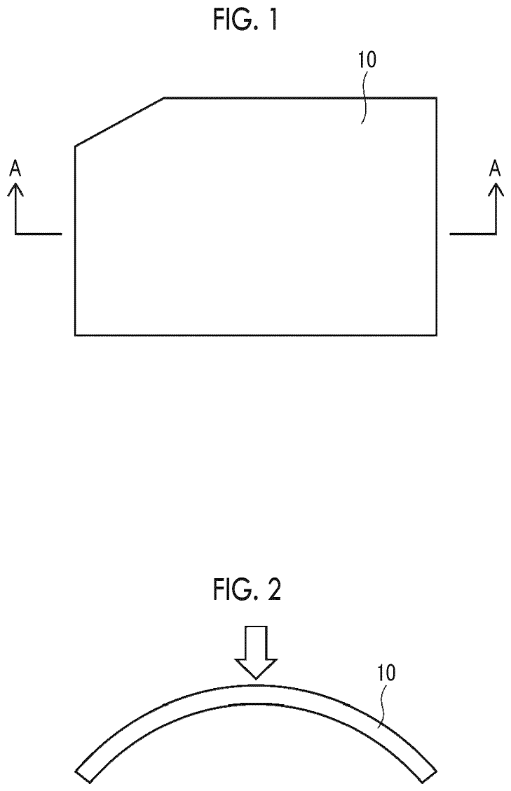

FIG. 1 shows an example of the light absorption anisotropic film according to the embodiment of the present invention.

FIG. 1 is a top view of the light absorption anisotropic film, and FIG. 2 is a cross-sectional view taken along a line A-A of FIG. 1.

As shown in FIGS. 1 and 2, a light absorption anisotropic film 10 has a curved surface shape. More specifically, as shown in FIG. 2, the light absorption anisotropic film 10 has a shape (convex shape) which is convexly curved toward the upper side of the paper plane. That is, the light absorption anisotropic film 10 has a convex shape protruding to one surface side. It can be said that the light absorption anisotropic film 10 has a concave shape in which the other surface side is concave.

In FIG. 1, an aspect in which the shape of the light absorption anisotropic film in a plan view is a pentagon is shown; but the present invention is not limited to this aspect, and the shape of the light absorption anisotropic film in a plan view may be a quadrangle, a circle, or another shape.

### [Transmittance Central Axis Angle θ]

As described above, the transmittance central axis angle θ of the light absorption anisotropic film according to the present invention is 0° or more and 45° or less, preferably 0° or more and less than 45°, more preferably 0° or more and 35° or less, and still more preferably 0° or more and less than 35°.

### [Liquid Crystal Composition]

As described above, the light absorption anisotropic film according to the present invention is a film formed by immobilizing an alignment state of a liquid crystal composition containing a liquid crystal compound, a dichroic substance, and a compound having a thiol group.

Hereinafter, components contained in the liquid crystal composition will be described in detail.

### <Liquid Crystal Compound>

The liquid crystal composition contains a liquid crystal compound. In this manner, the dichroic substance can be aligned with a higher alignment degree while the precipitation of the dichroic substance is suppressed.

Both a polymer liquid crystal compound and a low-molecular-weight liquid crystal compound can be used as the liquid crystal compound, and a polymer liquid crystal compound is preferable from the viewpoint that the alignment degree can be increased. Further, a polymer liquid crystal compound and a low-molecular-weight liquid crystal compound may be used in combination as the liquid crystal compound.

Here, the “polymer liquid crystal compound” refers to a liquid crystal compound having a repeating unit in the chemical structure.

In addition, the “low-molecular-weight liquid crystal compound” refers to a liquid crystal compound having no repeating unit in the chemical structure.

Examples of the polymer liquid crystal compound include thermotropic liquid crystal polymers described in JP2011-237513A and polymer liquid crystal compounds described in paragraphs [0012] to [0042] of WO2018/199096A.

Examples of the low-molecular-weight liquid crystal compound include liquid crystal compounds described in paragraphs [0072] to [0088] of JP2013-228706A, and among these, a liquid crystal compound exhibiting smectic properties is preferable.

Examples of such a liquid crystal compound include compounds described in paragraphs [0019] to [0140] of WO2022/014340A, the description of which is incorporated herein by reference.

It is preferable that the liquid crystal compound is a liquid crystal compound that does not exhibit dichroism in the visible light region.

A content of the liquid crystal compound is preferably 25 to 2,000 parts by mass, more preferably 100 to 1,300 parts by mass, and still more preferably 200 to 900 parts by mass with respect to 100 parts by mass of the dichroic substance described below. In a case where the content of the liquid crystal compound is within the above-described range, the alignment degree of the dichroic substance is further improved.

The light absorption anisotropic layer may contain only one or two or more kinds of liquid crystal compounds. In a case of containing two or more kinds of liquid crystal compounds, the above-described content of the liquid crystal compound means the total content of the liquid crystal compounds.

### <Dichroic Substance>

The liquid crystal composition contains a dichroic substance.

Here, the dichroic substance means a coloring agent having different absorbances depending on the direction.

In addition, the dichroic substance may or may not exhibit liquid crystallinity.

The dichroic substance is not particularly limited, and examples thereof include a visible light absorbing substance (dichroic coloring agent), a light emitting substance (fluorescent substance and phosphorescent substance), an ultraviolet absorbing substance, an infrared absorbing substance, a non-linear optical substance, a carbon nanotube, and an inorganic substance (for example, quantum rod). Further, known dichroic substances (dichroic coloring agents) of the related art can be used.

Specific examples thereof include those described in paragraphs [0067] to [0071] of JP2013-228706A, paragraphs [0008] to [0026] of JP2013-227532A, paragraphs [0008] to [0015] of JP2013-209367A, paragraphs [0045] to [0058] of JP2013-14883A, paragraphs [0012] to [0029] of JP2013-109090A, paragraphs [0009] to [0017] of JP2013-101328A, paragraphs [0051] to [0065] of JP2013-37353A, paragraphs [0049] to [0073] of JP2012-63387A, paragraphs [0016] to [0018] of JP1999-305036A (JP-H11-305036A), paragraphs [0009] to [0011] of JP2001-133630A, paragraphs [0030] to [0169] of JP2011-215337A, paragraphs [0021] to [0075] of JP2010-106242A, paragraphs [0011] to [0025] of JP2010-215846A, paragraphs [0017] to [0069] of JP2011-048311A, paragraphs [0013] to [0133] of JP2011-213610A, paragraphs [0074] to [0246] of JP2011-237513A, paragraphs [0005] to [0051] of JP2016-006502A, paragraphs [0014] to [0032] of JP2018-053167A, paragraphs [0014] to [0033] of JP2020-11716A, paragraphs [0005] to [0041] of WO2016/060173A, paragraphs [0008] to [0062] of WO2016/136561A, paragraphs [0014] to [0033] of WO2017/154835A, paragraphs [0014] to [0033] of WO2017/154695A, paragraphs [0013] to [0037] of WO2017/195833A, paragraphs [0014] to [0034] of WO2018/164252A, paragraphs [0021] to [0030] of WO2018/186503A, paragraphs [0043] to [0063] of WO2019/189345A, paragraphs [0043] to [0085] of WO2019/225468A, paragraphs [0050] to [0074] of WO2020/004106A, and paragraphs [0015] to [0038] of WO2021/044843A.

As the dichroic substance, a dichroic azo coloring agent compound is preferable.

The dichroic azo coloring agent compound means an azo coloring agent compound having different absorbances depending on directions. The dichroic azo coloring agent compound may or may not exhibit liquid crystallinity. In a case where the dichroic azo coloring agent compound exhibits liquid crystallinity, any of nematic properties or smectic properties may be exhibited. The temperature range in which the liquid crystal phase is exhibited is preferably room temperature (approximately 20° C. to 28° C.) to 300° C., and from the viewpoint of handleability and manufacturing suitability, more preferably 50° C. to 200° C.

In the present invention, from the viewpoint of tint adjustment, as the dichroic substance, it is preferable to use a mixture containing at least a coloring agent compound having a maximal absorption wavelength in a wavelength range of 380 nm or more and less than 455 nm (particularly, a dichroic azo coloring agent compound), a coloring agent compound having a maximal absorption wavelength in a wavelength range of 455 nm or more and less than 560 nm (particularly, a dichroic azo coloring agent compound), and a coloring agent compound having a maximal absorption wavelength in a wavelength range of 560 nm or more and 700 nm or less (particularly, a dichroic azo coloring agent compound).

In addition, in the present invention, it is preferable that the dichroic substance has a crosslinkable group.

Examples of the crosslinkable group include cationically polymerizable groups such as an epoxy group, an epoxycyclohexyl group, and an oxetanyl group; and radically polymerizable groups such as an acryloyl group, a methacryloyl group, a vinyl group, a styryl group, and an allyl group.

The content of the dichroic substance contained in the light absorption anisotropic film is not particularly limited, but from the viewpoint of increasing the alignment degree of the light absorption anisotropic film to be formed, the content is preferably 3% by mass or more, more preferably 8% by mass or more, still more preferably 10% by mass or more, and particularly preferably 10% to 30% by mass with respect to the total mass of the light absorption anisotropic film. In a case where a plurality of dichroic substances are used in combination, the total amount of the plurality of dichroic substances is preferably within the above range.

In addition, from the viewpoint of increasing the alignment degree of the light absorption anisotropic film to be formed, the content of the dichroic substance contained in the light absorption anisotropic film is preferably 20 to 650 mg/cm³, more preferably 25 to 500 mg/cm³, still more preferably 30 to 200 mg/cm³, and even still more preferably 40 to 150 mg/cm³. In a case where a plurality of dichroic substances are used in combination, the total amount of the plurality of dichroic substances is preferably within the above range.

Here, the content (mg/cm³) of the dichroic substance is obtained by measuring a solution in which a laminate including the light absorption anisotropic film is dissolved, or an extraction liquid obtained by immersing the laminate in a solvent, using high performance liquid chromatography (HPLC); but the measurement method is not limited to the above-described method. In addition, the quantification can be performed by using the dichroic substance contained in the light absorption anisotropic film as a standard sample.

Examples of the method of calculating the content of the dichroic substance include a method in which the volume is calculated by multiplying the thickness of the light absorption anisotropic film obtained from a microscopic observation image of a cross section of the laminate by the area of the optical laminate used for measuring the coloring agent amount, and is divided by the coloring agent amount measured by HPLC to calculate the content of the coloring agent.

### Compound Having Thiol Group

The liquid crystal composition contains a compound having a thiol group (hereinafter, also abbreviated as “thiol compound”).

Here, the thiol compound is not particularly limited as long as it is a compound having one or more thiol groups (—SH) in the molecule.

In addition, the order of the thiol group is not particularly limited, and may be, for example, any of primary, secondary, or tertiary. The α-position means a carbon atom to which the thiol group is bonded. Hereinafter, the same applies.); a thiol group in which two hydrogen atoms are bonded to the α-position is a primary thiol group; a thiol group in which one hydrogen atom is bonded to the α-position is a secondary thiol group; and a thiol group in which a hydrogen atom is not bonded to the α-position is a tertiary thiol group.

In the present invention, from the reason that the variation in film thickness of the curved surface portion and the occurrence of cracks are further suppressed, the thiol compound is preferably a compound having two or more primary or secondary thiol groups in one molecule, and more preferably a compound having two to four primary or secondary thiol groups in one molecule.

In the present invention, from the reason that the storage stability of the liquid crystal composition is improved, at least one of the thiol groups of the thiol compound is preferably a secondary thiol group, and all of the thiol groups present in the molecule of the thiol compound are more preferably a secondary thiol group.

In the present invention, from the reason that the occurrence of cracks and the variation in film thickness of the curved surface portion (particularly, the three-dimensional curved surface) are further suppressed, a thiol equivalent of the thiol compound, that is, a mass (g/eq) of the thiol compound corresponding to 1 mol of the thiol group is preferably 200 or less, more preferably 100 to 200, and still more preferably 100 to 150.

Examples of the thiol compound include:
primary thiol compounds such as 3-mercaptopropionic acid, 2-ethylhexyl-3-mercaptopropionate, methoxybutyl-β-mercaptopropionate, stearyl-3-mercaptopropionate, ethylene glycol dimercaptopropionate, tetraethylene glycol bis(3-mercaptopropionate), and 2,2-bis[[3-mercaptopropionyloxy]methyl]trimethylene bis[3-mercaptopropionate];
secondary thiol compounds such as pentaerythritol tetrakis(3-mercaptobutyrate), 1,4-bis(3-mercaptopropionyloxy)butane, 1,3,5-tris(2-(3-sulfanylbutanoyloxy)ethyl)-1,3,5-triazinan-2,4,6-trione, and trimethylolpropane tris(3-mercaptobutyrate);

Examples thereof include the following.

In the present invention, from the reason of suppressing the occurrence of the variation in film thickness and cracks while maintaining a high alignment degree of the dichroic coloring agent, the content of the thiol group compound is preferably 5% to 15% by mass and more preferably 6% to 12% by mass with respect to the total solid content mass of the liquid crystal composition.

### <Vertical Alignment Agent>

The liquid crystal composition preferably contains a vertical alignment agent.

Here, the vertical alignment agent refers to an additive having a function of aligning the above-described liquid crystal compound in a direction perpendicular to the main plane of the light absorption anisotropic film. The term “aligning in a direction perpendicular to” does not require the alignment at exactly 90°, but means the alignment at 70° to 110°.

Examples of the vertical alignment agent include an ionic vertical alignment agent and a vertical alignment agent having a boronic acid group, and it is preferable to use an ionic vertical alignment agent and a vertical alignment agent having a boronic acid group in combination.

Suitable examples of the ionic vertical alignment agent include an onium compound represented by Formula (B1).

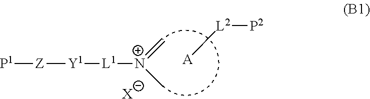

In Formula (B1), a ring A represents a quaternary ammonium ion consisting of a nitrogen-containing heterocyclic ring.

In addition, X represents an anion.

In addition, L¹ represents a divalent linking group.

In addition, L² represents a single bond or a divalent linking group.

In addition, Y¹ represents a divalent linking group having a 5-membered ring or a 6-membered ring as a partial structure.

In addition, Z represents a divalent linking group having an alkylene group having 2 to 20 carbon atoms as a partial structure.

In addition, P¹ and P² each independently represent a monovalent substituent having a polymerizable ethylenically unsaturated bond.

The ring A represents a quaternary ammonium ion consisting of a nitrogen-containing heterocyclic ring. Examples of the ring A include a pyridine ring, a picoline ring, a 2,2′-bipyridyl ring, a 4,4′-bipyridyl ring, a 1,10-phenanthroline ring, a quinoline ring, an oxazole ring, a thiazole ring, an imidazole ring, a pyrazine ring, a triazole ring, and a tetrazole ring, and the ring A is preferably a quaternary imidazolium ion or a quaternary pyridinium ion.

X represents an anion. Examples of X include a halogen anion (for example, a fluorine ion, a chlorine ion, a bromine ion, an iodine ion, and the like), a sulfonate ion (for example, a methanesulfonate ion, a trifluoromethanesulfonate ion, a methylsulfate ion, a vinylsulfonate ion, an allylsulfonate ion, a p-toluenesulfonate ion, a p-chlorobenzenesulfonate ion, a p-vinylbenzenesulfonate ion, a 1,3-benzenedisulfonate ion, a 1,5-naphthalenedisulfonate ion, a 2,6-naphthalenedisulfonate ion, and the like), a sulfate ion, a carbonate ion, a nitrate ion, a thiocyanate ion, a perchlorate ion, a tetrafluoroborate ion, a picrate ion, an acetate ion, a benzoate ion, a p-vinyl benzoate ion, a formate ion, a trifluoroacetate ion, a phosphate ion (for example, hexafluorophosphate ion), and a hydroxide ion. X is preferably a halogen anion, a sulfonate ion, or a hydroxide ion. In addition, a chlorine ion, a bromine ion, an iodine ion, a methanesulfonate ion, a vinylsulfonate ion, a p-toluenesulfonate ion, or a p-vinylbenzenesulfonate ion is particularly preferable.

L¹ represents a divalent linking group. Examples of L¹ include a divalent linking group having 1 to 20 carbon atoms, consisting of a combination of an alkylene group, —O—, —S—, —CO—, —SO₂—, —NRa— (here, Ra is an alkyl group having 1 to 5 carbon atoms or a hydrogen atom), an alkenylene group, an alkynylene group, and an arylene group. L¹ is preferably -AL-, —O-AL-, —CO—O-AL-, or —O—CO-AL-, each of which has 1 to 10 carbon atoms, more preferably -AL- or —O-AL-, each of which has 1 to 10 carbon atoms, and most preferably -AL- or —O-AL-, each of which has 1 to 5 carbon atoms. AL represents an alkylene group.

L² represents a single bond or a divalent linking group. Examples of L² include a divalent linking group having 1 to 10 carbon atoms, consisting of a combination of an alkylene group, —O—, —S—, —CO—, —SO₂—, —NRa— (here, Ra is an alkyl group having 1 to 5 carbon atoms or a hydrogen atom), an alkenylene group, an alkynylene group, and an arylene group; a single bond, —O—, —O—CO—, —CO—O—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO—, and —O—CO-AL-CO—O—. AL represents an alkylene group. L² is preferably a single bond, -AL-, —O-AL-, or —NRa-AL-O—, each of which has 1 to 10 carbon atoms, more preferably a single bond, -AL-, —O-AL-, or —NRa-AL-O—, each of which has 1 to 5 carbon atoms, and most preferably a single bond, —O-AL-, or —NRa-AL-O—, each of which has 1 to 5 carbon atoms.

Y¹ represents a divalent linking group having a 5- or 6-membered ring as a partial structure. Examples of Y¹ include a cyclohexyl ring, an aromatic ring, or a heterocyclic ring. Examples of the aromatic ring include a benzene ring, an indene ring, a naphthalene ring, a fluorene ring, a phenanthrene ring, an anthracene ring, a biphenyl ring, and a pyrene ring, and a benzene ring, a biphenyl ring, or a naphthalene ring is particularly preferable. As a heteroatom constituting the heterocyclic ring, a nitrogen atom, an oxygen atom, or a sulfur atom is preferable, and examples of the heterocyclic ring include a furan ring, a thiophene ring, a pyrrole ring, a pyrroline ring, a pyrrolidine ring, an oxazole ring, an isoxazole ring, a thiazole ring, an isothiazole ring, an imidazole ring, an imidazoline ring, an imidazolidine ring, a pyrazole ring, a pyrazoline ring, a pyrazolidine ring, a triazole ring, a furazan ring, a tetrazole ring, a pyran ring, a dioxane ring, a dithiane ring, a thiin ring, a pyridine ring, a piperidine ring, an oxazine ring, a morpholine ring, a thiazine ring, a pyridazine ring, a pyrimidine ring, a pyrazine ring, a piperazine ring, and a triazine ring. The heterocyclic ring is preferably a 6-membered ring. The divalent linking group represented by Y¹, having a 5- or 6-membered ring as a partial structure, may further have a substituent (for example, the above-described substituent W).

The divalent linking group represented by Y¹ is preferably a divalent linking group having two or more 5- or 6-membered rings, and more preferably has a structure in which two or more rings are linked to each other through a linking group. Examples of the linking group include the examples of the linking group represented by L¹ and L², —C≡C—, —CH═CH—, —CH═N—, —N═CH—, and —N═N—.

Z represents a divalent linking group which has an alkylene group having 2 to 20 carbon atoms as a partial structure and consists of a combination of —O—, —S—, —CO—, and —SO₂—, in which the alkylene group may have a substituent. Examples of the above-described divalent linking group include an alkyleneoxy group and a polyalkyleneoxy group. The number of carbon atoms in the alkylene group represented by Z is more preferably 2 to 16, still more preferably 2 to 12, and particularly preferably 2 to 8.

P¹ and P² each independently represent a monovalent substituent having a polymerizable ethylenically unsaturated group. Examples of the above-described monovalent substituent having a polymerizable ethylenically unsaturated group include Formulae (M-1) to (M-8). That is, the monovalent substituent having a polymerizable ethylenically unsaturated group may be a substituent consisting of only an ethenyl group as in Formula (M-8).

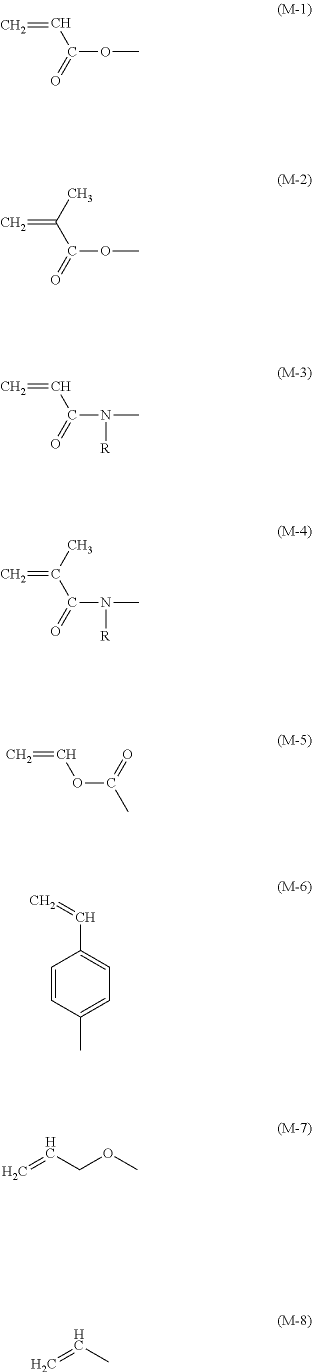

In Formulae (M-3) and (M-4), R represents a hydrogen atom or an alkyl group, and a hydrogen atom or a methyl group is preferable. Among Formulae (M-1) to (M-8), (M-1), (M-2), or (M-8) is preferable, and (M-1) or (M-8) is more preferable. In particular, P¹ is preferably (M-1). In addition, P² is preferably (M-1) or (M-8), and in a compound in which the ring A is quaternary imidazolium ion, P² is preferably (M-8) or (M-1), and in a compound in which the ring A is a quaternary pyridinium ion, P² is preferably (M-1).

Examples of the onium compound represented by Formula (B1) include onium salts described in paragraphs 0052 to 0058 of JP2012-208397A, onium salts described in paragraphs 0024 to 0055 of JP2008-026730A, and onium salts described in JP2002-37777A.

Examples of the ionic vertical alignment agent include those described in paragraphs [0017] to [0029] of JP2020-181150A, in addition to the onium compound represented by Formula (B1).

Suitable examples of the vertical alignment agent having a boronic acid group include a boronic acid compound represented by Formula (B2).

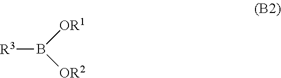

In (B2), R¹ and R² each independently represent a hydrogen atom, an aliphatic hydrocarbon group which may have a substituent, an aryl group which may have a substituent, or a heterocyclic group which may have a substituent.

In addition, R³ represents a substituent.

Examples of the aliphatic hydrocarbon group represented by one aspect of R¹ and R² include a linear or branched alkyl group having 1 to 20 carbon atoms, which may be substituted or unsubstituted, (for example, a methyl group, an ethyl group, an iso-propyl group, and the like), a substituted or unsubstituted cyclic alkyl group having 3 to 20 carbon atoms (for example, a cyclohexyl group and the like), and an alkenyl group having 2 to 20 carbon atoms (for example, a vinyl group and the like).

In addition, examples of the aryl group represented by one aspect of R¹ and R² include a substituted or unsubstituted phenyl group having 6 to 20 carbon atoms (for example, a phenyl group, a tolyl group, and the like), and a substituted or unsubstituted naphthyl group having 10 to 20 carbon atoms.

In addition, examples of the heterocyclic group represented by one aspect of R¹ and R² include a substituted or unsubstituted 5-membered or 6-membered ring group including at least one heteroatom (for example, a nitrogen atom, an oxygen atom, a sulfur atom, and the like), and specific examples thereof include a pyridyl group, an imidazolyl group, a furyl group, a piperidyl group, and a morpholino group.

R¹ and R² may be linked to each other to form a ring. For example, isopropyl groups of R¹ and R² may be linked to each other to form a 4,4,5,5-tetramethyl-1,3,2-dioxaborolane ring.

As R¹ and R², a hydrogen atom, a linear or branched alkyl group having 1 to 3 carbon atoms, or an aspect in which these groups are linked to each other to form a ring is preferable, and a hydrogen atom is more preferable.

As the substituent represented by R³, a substituent including a functional group which can be bonded to a (meth)acrylic group is preferable.

Here, examples of the functional group which can be bonded to a (meth)acrylic group include a vinyl group, an acrylate group, a methacrylate group, an acrylamide group, a styryl group, a vinyl ketone group, a butadiene group, a vinyl ether group, an oxiranyl group, an aziridinyl group, and an oxetane group. Among these, a vinyl group, an acrylate group, a methacrylate group, a styryl group, an oxiranyl group, or an oxetane group is preferable, and a vinyl group, an acrylate group, an acrylamide group, or a styryl group is more preferable.

R³ is preferably a substituted or unsubstituted aliphatic hydrocarbon group, aryl group, or heterocyclic group having the functional group which can be bonded to a (meth)acrylic group.

Examples of the aliphatic hydrocarbon group include a substituted or unsubstituted linear or branched alkyl group having 1 to 30 carbon atoms (for example, a methyl group, an ethyl group, an iso-propyl group, an n-propyl group, a butyl group, a pentyl group, a hexyl group, a heptyl group, an octyl group, a nonyl group, a decyl group, an undecyl group, a dodecyl group, a tridecyl group, a hexadecyl group, an octadecyl group, an eicosyl group, an isopropyl group, an isobutyl group, an sec-butyl group, a tert-butyl group, an isopentyl group, a neopentyl group, a 1-methylbutyl group, an isohexyl group, a 2-methylhexyl group, and the like), a substituted or unsubstituted cyclic alkyl group having 3 to 20 carbon atoms (for example, a cyclopentyl group, a cyclohexyl group, a 1-adamantyl group, a 2-norbornyl group, and the like), and an alkenyl group having 2 to 20 carbon atoms (for example, a vinyl group, a 1-propenyl group, a 1-butenyl group, a 1-methyl-1-propenyl group, and the like).

Examples of the aryl group include a substituted or unsubstituted phenyl group having 6 to 50 carbon atoms (for example, a phenyl group, a tolyl group, a styryl group, a 4-benzoyloxyphenyl group, a 4-phenoxycarbonylphenyl group, a 4-biphenyl group, a 4-(4-octyloxybenzoyloxy)phenoxycarbonylphenyl group, and the like), and a substituted or unsubstituted naphthyl group having 10 to 50 carbon atoms (for example, an unsubstituted naphthyl group and the like).

The heterocyclic group is, for example, a substituted or unsubstituted 5-membered or 6-membered ring group including at least one heteroatom (for example, a nitrogen atom, an oxygen atom, a sulfur atom, and the like), and examples thereof include groups of pyrrole, furan, thiophene, pyrazole, imidazole, triazole, oxazole, isoxazole, oxadiazole, thiazole, thiadiazole, indole, carbazole, benzofuran, dibenzofuran, thianaphthene, dibenzothiophene, indazole, benzimidazole, anthranil, benzisoxazole, benzoxazole, benzothiazole, purine, pyridine, pyridazine, pyrimidine, pyrazine, triazine, quinoline, acridine, isoquinoline, phthalazine, quinazoline, quinoxaline, naphthyridine, phenanthroline, pteridine, morpholine, and piperidine, and the like.

Examples of the boronic acid compound represented by Formula (B2) include a boronic acid compound represented by General Formula (I) described in paragraphs 0023 to 0032 of JP2008-225281A.

As the compound represented by Formula (B2), compounds exemplified below are also preferable.

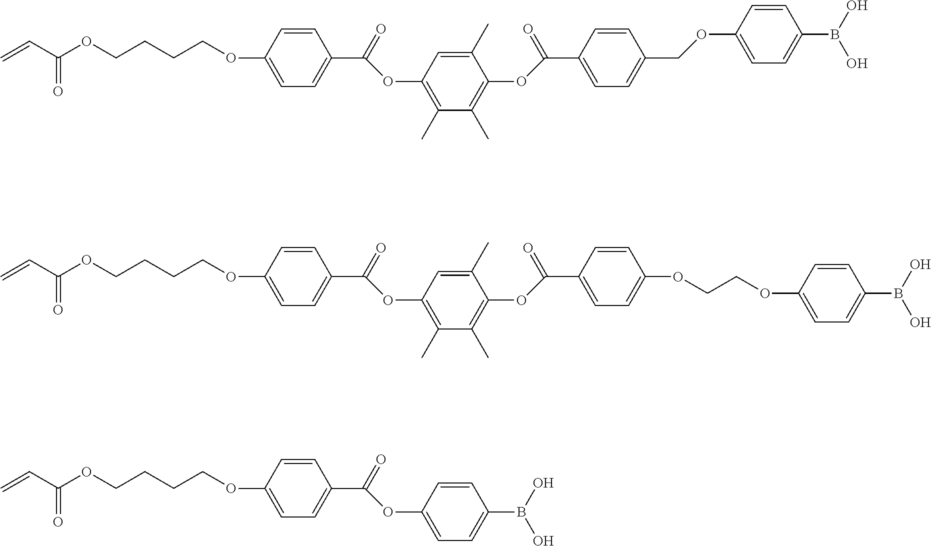 [SMILES: C=CC(=O)OCCCCOc1ccc(C(=O)Oc2cc(C)c(OC(=O)c3ccc(COc4ccc(B(O)O)cc4)cc3)c(C)c2C)cc1 ; C=CC(=O)OCCCCOc1ccc(C(=O)Oc2cc(C)c(OC(=O)c3ccc(OCCOc4ccc(B(O)O)cc4)cc3)c(C)c2C)cc1 ; C=CC(=O)OCCCCOc1ccc(C(=O)Oc2ccc(B(O)O)cc2)cc1]

The content of any vertical alignment agent contained in the light absorption anisotropic film is preferably 1.0 to 7.0 parts by mass, more preferably 1.5 to 8.0 parts by mass, and still more preferably 2.5 to 6.0 parts by mass with respect to 100 parts by mass of the content of the liquid crystal compound.

The liquid crystal composition may include only one kind of the vertical alignment agent, or may include two or more kinds thereof. In a case where the liquid crystal composition contains two or more kinds of liquid crystal compounds, the content of the vertical alignment agent means the total content of the vertical alignment agents.

### <Solvent>

From the viewpoint of workability and the like, it is preferable that the liquid crystal composition contains a solvent.

Examples of the solvent include organic solvents such as ketones (such as acetone, 2-butanone, methyl isobutyl ketone, cyclopentanone, cyclohexanone, and acetylacetone), ethers (such as dioxane, tetrahydrofuran, tetrahydropyran, dioxolane, tetrahydrofurfuryl alcohol, cyclopentyl methyl ether, and dibutyl ether), aliphatic hydrocarbons (such as hexane), alicyclic hydrocarbons (such as cyclohexane), aromatic hydrocarbons (such as benzene, toluene, xylene, tetralin, and trimethylbenzene), halogenated carbons (such as dichloromethane, trichloromethane (chloroform), dichloroethane, dichlorobenzene, 1,1,2,2-tetrachloroethane, and chlorotoluene), esters (such as methyl acetate, ethyl acetate, butyl acetate, diethyl carbonate, ethyl acetoacetate, n-pentyl acetate, ethyl benzoate, benzyl benzoate, butyl carbitol acetate, diethylene glycol monoethyl ether acetate, and isoamyl acetate), alcohols (such as ethanol, isopropanol, butanol, cyclohexanol, furfuryl alcohol, 2-ethylhexanol, octanol, benzyl alcohol, ethanolamine, ethylene glycol, propylene glycol, diethylene glycol, diethylene glycol monomethyl ether, diethylene glycol monoethyl ether, and diethylene glycol monobutyl ether), phenols (such as phenol and cresol), cellosolves (such as methyl cellosolve, ethyl cellosolve, and 1,2-dimethoxyethane), cellosolve acetates, sulfoxides (such as dimethyl sulfoxide), amides (such as dimethylformamide, dimethylacetamide, N-methylpyrrolidone, N-ethylpyrrolidone, and 1,3-dimethyl-2-imidazolidinone), and heterocyclic compounds (such as pyridine and 2,6-lutidine); and water.

These solvents may be used alone or in combination of two or more kinds thereof.

In a case where the liquid crystal composition contains a solvent, a content of the solvent is preferably 60% to 99.5% by mass, more preferably 70% to 99% by mass, and particularly preferably 75% to 98% by mass with respect to the total mass (100% by mass) of the liquid crystal composition.

### <Polymerization Initiator>

The liquid crystal composition may contain a polymerization initiator.

The polymerization initiator is not particularly limited, but a compound having photosensitivity, that is, a photopolymerization initiator is preferable.

As the photopolymerization initiator, various compounds can be used without any particular limitation. Examples of the photopolymerization initiator include α-carbonyl compounds (U.S. Pat. Nos. 2,367,661A and 2,367,670A), acyloin ether (U.S. Pat. No. 2,448,828A), α-hydrocarbon-substituted aromatic acyloin compounds (U.S. Pat. No. 2,722,512A), polynuclear quinone compounds (U.S. Pat. Nos. 3,046,127A and 2,951,758A), a combination of a triarylimidazole dimer and a p-aminophenyl ketone (U.S. Pat. No. 3,549,367A), acridine and phenazine compounds (JP1985-105667A (JP-S60-105667A) and U.S. Pat. No. 4,239,850A), oxadiazole compounds (U.S. Pat. No. 4,212,970A), o-acyloxime compounds ([0065] of JP2016-27384A), and acylphosphine oxide compounds (JP1988-40799B (JP-S63-40799B), JP1993-29234B (JP-H5-29234B), JP1998-95788A (JP-H10-95788A), and JP1998-29997A (JP-H10-29997A)).

Commercially available products can also be used as such a photopolymerization initiator, and examples thereof include IRGACURE-184, IRGACURE-907, IRGACURE-369, IRGACURE-651, IRGACURE-819, IRGACURE-OXE-01, and IRGACURE-OXE-02, manufactured by BASF SE.

In a case where the liquid crystal composition contains a polymerization initiator, a content of the polymerization initiator is preferably 0.01% to 30% by mass and more preferably 0.1% to 15% by mass with respect to the total solid content mass of the liquid crystal composition.

### <Interface Improver>

The liquid crystal composition may contain an interface improver.

The interface improver is not particularly limited, and a polymer-based interface improver or a low-molecular-weight interface improver can be used, and compounds described in paragraphs [0253] to [0293] of JP2011-237513A can also be used.

In addition, fluorine (meth)acrylate-based polymers described in paragraphs [0018] to [0043] of JP2007-272185A can also be used as the interface improver.

In addition, examples of the interface improver include compound described in the description of paragraphs [0079] to [0102] of JP2007-069471A, polymerizable liquid crystal compounds represented by Formula (4) described in JP2013-047204A (particularly, compounds described in paragraphs [0020] to [0032]), polymerizable liquid crystal compounds represented by Formula (4) described in JP2012-211306A (particularly, compounds described in paragraphs [0022] to [0029]), liquid crystal alignment promoters represented by Formula (4) described in JP2002-129162A (particularly, compounds described in paragraphs [0076] to [0078] and paragraphs [0082] to [0084]), compounds represented by Formulae (4), (II), and (III) described in JP2005-099248A (particularly, compounds described in paragraphs [0092] to [0096]), compounds described in paragraphs [0013] to [0059] of JP4385997B, compounds described in paragraphs [0018] to [0044] of JP5034200B, and compounds described in paragraphs [0019] to [0038] of JP4895088B.

The interface improvers may be used alone or in combination of two or more kinds thereof.

In a case where the liquid crystal composition contains an interface improver, a content of the interface improver is preferably 0.005% to 15% by mass, more preferably 0.01% to 5% by mass, and still more preferably 0.015% to 3% by mass with respect to the total solid content mass of the liquid crystal composition. In a case where a plurality of interface improvers are used in combination, it is preferable that the total amount of the plurality of interface improvers is within the above-described range.

### [Method of Forming Light Absorption Anisotropic Film]

A method of forming the light absorption anisotropic film is not particularly limited, and examples thereof include a method including, in the following order, a step of applying the above-described liquid crystal composition (hereinafter, also referred to as “composition for forming a light absorption anisotropic film”) to form a coating film (hereinafter, also referred to as “coating film forming step”) and a step of aligning a liquid crystalline component or a dichroic substance contained in the coating film (hereinafter, also referred to as “alignment step”).

In a case where the above-described dichroic substance has liquid crystallinity, the liquid crystalline component is a component which also includes the dichroic substance having liquid crystallinity in addition to the above-described liquid crystal compound.

### <Coating Film Forming Step>

The coating film forming step is a step of applying the composition for forming a light absorption anisotropic film to form a coating film.

The alignment film can be easily coated with the composition for forming a light absorption anisotropic film by using the composition for forming a light absorption anisotropic film which contains the above-described solvent or using a liquid-like material such as a melt obtained by heating the composition for forming a light absorption anisotropic film.

Specific examples of the method of coating the film with the composition for forming a light absorption anisotropic film include known methods such as a roll coating method, a gravure printing method, a spin coating method, a wire bar coating method, an extrusion coating method, a direct gravure coating method, a reverse gravure coating method, a die coating method, a spraying method, and an ink jet method.

In the present invention, from the viewpoint of increasing the optical effect (for example, viewing angle control), the coating amount of the dichroic substance in the coating film forming step is preferably 15 mg/m² or more, more preferably 50 to 1,000 mg/m², and still more preferably 200 to 800 mg/m².

### <Alignment Step>

The alignment step is a step of aligning the liquid crystalline component contained in the coating film. In this manner, the light absorption anisotropic film is obtained.

The alignment step may include a drying treatment. Components such as a solvent can be removed from the coating film by performing the drying treatment. The drying treatment may be performed according to a method of allowing the coating film to stand at room temperature for a predetermined time (for example, natural drying) or a method of heating the coating film and/or blowing air to the coating film.

Here, the liquid crystal component contained in the composition for forming a light absorption anisotropic film may be aligned by the coating film forming step or the drying treatment described above. For example, in an embodiment in which the composition for forming a light absorption anisotropic film is prepared as a coating solution containing a solvent, a coating film having light absorption anisotropy (that is, a light absorption anisotropic film) is obtained by drying the coating film and removing the solvent from the coating film.

In a case where the drying treatment is performed at a temperature higher than or equal to a transition temperature of the liquid crystalline component contained in the coating film to the liquid crystal phase, a heat treatment described below may not be performed.

From the viewpoint of manufacturing suitability or the like, the transition temperature of the liquid crystalline component contained in the coating film to the liquid crystal phase is preferably 10° C. to 250° C. and more preferably 25° C. to 190° C. In a case where the above-described transition temperature is 10° C. or higher, a cooling treatment or the like for lowering the temperature to a temperature range in which the liquid crystal phase is exhibited is not necessary, which is preferable. In addition, in a case where the above-described transition temperature is 250° C. or lower, a high temperature is not required even in a case of setting an isotropic liquid state at a temperature higher than the temperature range in which the liquid crystal phase is temporarily exhibited, and waste of thermal energy and deformation and deterioration of a substrate can be reduced, which is preferable.

It is preferable that the alignment step includes a heat treatment. In this manner, since the liquid crystalline component contained in the coating film can be aligned, the coating film after being subjected to the heat treatment can be suitably used as the light absorption anisotropic film.

From the viewpoint of the manufacturing suitability, the heat treatment is performed at a temperature of preferably 10° C. to 250° C. and more preferably 25° C. to 190° C. Further, the heating time is preferably in a range of 1 to 300 seconds and more preferably in a range of 1 to 60 seconds.

The alignment step may include a cooling treatment performed after the heat treatment. The cooling treatment is a treatment of cooling the heated coating film to room temperature (20° C. to 25° C.). In this manner, the alignment of the liquid crystalline component contained in the coating film can be fixed. The cooling means is not particularly limited and can be performed according to a known method.

The light absorption anisotropic film can be obtained by performing the above-described steps.

In the present embodiment, examples of a method of aligning the liquid crystalline component contained in the coating film include the drying treatment and the heat treatment, but the present invention is not limited thereto, and the liquid crystalline component can be aligned by a known alignment treatment.

### <Other Steps>

The method of forming the light absorption anisotropic film may include a step of curing the light absorption anisotropic film after the alignment step (hereinafter, also referred to as a “curing step”).

For example, in a case where the light absorption anisotropic film has a crosslinkable group (polymerizable group), the curing step is performed by heating and/or light irradiation (exposure). Between these, it is preferable that the curing step is performed by irradiating the film with light.

Various light sources such as infrared rays, visible light, and ultraviolet rays can be used as the light source for curing, but ultraviolet rays are preferable. In addition, ultraviolet rays may be applied while the layer is heated during curing, or ultraviolet rays may be applied through a filter which transmits only a specific wavelength.

In a case where the exposure is performed while the layer is heated, the heating temperature during the exposure depends on the transition temperature of the liquid crystalline component contained in the liquid crystal film to the liquid crystal phase, but it is preferably 25° C. to 140° C.

In addition, the exposure may be performed under a nitrogen atmosphere. In a case where the curing of the liquid crystal film proceeds by radical polymerization, since inhibition of polymerization by oxygen is reduced, it is preferable that the exposure is performed in a nitrogen atmosphere.

In the present invention, the thickness of the light absorption anisotropic film is not particularly limited, but from the reason that the light shielding properties in an oblique direction can be improved and the alignment degree of the light absorption anisotropic film is increased, the thickness is preferably 1.5 μm or more, more preferably 2 to 10 μm, and still more preferably 2 to 8 μm.

Here, the thickness of the light absorption anisotropic film is measured by cutting the light absorption anisotropic layer using a microtome to prepare a sample having a cross section, observing the cross section with a scanning electron microscope from a normal direction with respect to the cross section, and measuring the thickness.

In the present invention, in a case of being applied to an image display apparatus, from the viewpoint of suppressing tinting of a display screen, a difference in the alignment degree of the light absorption anisotropic film at a wavelength of 450 nm, 550 nm, and 650 nm is preferably 0.025 or less, more preferably 0.020 or less, and still more preferably 0.010 or less.

Here, as the alignment degree of the light absorption anisotropic film at wavelengths of 450 nm, 550 nm, and 650 nm, values calculated by the following method are adopted.

Specifically, the Mueller matrix is measured at polar angles in a range of −70° to 700 at intervals of 5° in the in-plane slow axis direction using AxoScan (manufactured by Axometrics, Inc.), and kx(λ), ky(λ), and kz(λ) are obtained by fitting.

Next, the absorption anisotropies Ao(λ) and Ae(λ) are obtained according to the following equations (A) to (D), and the alignment degree S is calculated according to the following equation (E).

$$To ( λ ) = EXP \{ - 4 \times π \times ( kx ( λ ) + ky ( λ ) ) / 2 \times d / λ \} \qquad ( A )$$

$$Te ( λ ) = EXP \{ - 4 \times π \times kz ( λ ) \times d / λ \} \qquad ( B )$$

$$Ao ( λ ) = - log ( To ( λ ) ) \qquad ( C )$$

$$Ae ( λ ) = - log ( Te ( λ ) ) \qquad ( D )$$

$$Alignment degree S ( λ ) = [ Ao ( λ ) / Ae ( λ ) - 1 ] / [ Ao ( λ ) / Ae ( λ ) + 2 ] \qquad ( E )$$

Here, d represents a film thickness (nm) of the light absorption anisotropic film, To(λ) and Te(λ) represent transmittance, and Ao(λ) and Ae(λ) represent absorbance.

The difference in the alignment degrees (0.025 or less) defined in Requirement 3 described above refers to the maximum difference among the difference in the alignment degrees at each of the wavelengths of 450 nm and 550 nm, the difference in the alignment degrees at each of the wavelengths of 450 nm and 650 nm, and the difference in the alignment degrees at each of the wavelengths of 550 nm and 650 nm.

In addition, in the present invention, from the viewpoint of absorbing a larger amount of polarized light incident from a specific direction into the light absorption anisotropic film and obtaining preferable optical performance, the alignment degree of the light absorption anisotropic film at a wavelength of 550 nm is preferably 0.94 or more, more preferably 0.95 to 1.00, and still more preferably 0.96 to 1.00.

Here, the alignment degree of the light absorption anisotropic film at a wavelength of 550 nm can be calculated by the above-described method.

In addition, from the viewpoint of easily making a difference in the alignment degree of the light absorption anisotropic film at a wavelength of 450 nm, 550 nm, and 650 nm to be 0.025 or less, it is preferable to perform the heating treatment in the above-described alignment step a plurality of times (particularly, twice).

In addition, the cooling treatment performed between the two heating treatments is preferably a treatment of cooling the coating film after the first heating treatment to approximately 30° C. to 45° C.

In the present invention, from the viewpoint of maintaining a high degree of polarization of light passing through the light absorption anisotropic film and further improving optical performance, the haze value of the light absorption anisotropic film is preferably 0.3% or less, more preferably 0.2% or less, and still more preferably 0.1% or less.

Here, the haze value refers to haze measured in accordance with “Method of Obtaining Haze of Plastic—Transparent Materials” of JIS K7136:2000, and refers to a value measured with a haze meter (for example, NDH2000 (manufactured by Nippon Denshoku Industries Co., Ltd.)) in an environment of 25° C. and a relative humidity of 55%.

In addition, from the viewpoint of easily setting the haze value of the light absorption anisotropic film to 0.3% or less, it is preferable to perform the heating treatment in the alignment step described above a plurality of times (particularly, twice). In particular, it is preferable to lower the temperature in the two heating treatments, and specifically, the temperature is more preferably 65° C. to 80° C.

### [Laminate]

The laminate according to the embodiment of the present invention has the light absorption anisotropic film according to the present invention.

In addition, the laminate according to the embodiment of the present invention may have at least one layer of a polarizer layer, an antireflection layer, or a retardation layer.

### [Polarizer Layer]

The polarizer layer is not particularly limited as long as it is a member functioning to convert light into specific linearly polarized light. An absorption-type polarizer or a reflection-type polarizer which has been known can be used.

An iodine-based polarizer, a dye-based polarizer using a dichroic dye, a polyene-based polarizer, or the like is used as the absorptive type polarizer. The iodine-based polarizer and the dye-based polarizer include a coating type polarizer and a stretching type polarizer, and any of these polarizers can be applied, but a coating type polarizer is preferable.

In addition, examples of a method of obtaining a polarizer by carrying out stretching and dying in a state of a laminated film in which a polyvinyl alcohol layer is formed on a base material include the methods disclosed in JP5048120B, JP5143918B, JP4691205B, JP4751481B, and JP4751486B, and known technologies relating to these polarizers can also be preferably used.

Examples of the coating type polarizer include those in WO2018/124198A, WO2018/186503A, WO2019/132020A, WO2019/132018A, WO2019/189345A, JP2019-197168A, JP2019-194685A, and JP2019-139222A, and known techniques relating to these polarizers can also be preferably used.

A polarizer in which thin films having different birefringence are laminated, a wire grid-type polarizer, a polarizer having a combination of a cholesteric liquid crystal having a selective reflection range, a ¼ wavelength plate, and the like is used as the reflective type polarizer.

Among these, from the viewpoint of more excellent adhesiveness, a polarizer including a polyvinyl alcohol-based resin (a polymer including —CH₂—CHOH— as a repeating unit, in particular, at least one selected from the group consisting of a polyvinyl alcohol and an ethylene-vinyl alcohol copolymer) is preferable. In particular, at least one selected from the group consisting of a polyvinyl alcohol and an ethylene-vinyl alcohol copolymer) is preferable.

In addition, from the viewpoint of imparting crack resistance, the polarizer may have a depolarization unit formed along the opposite end edges. Examples of the depolarization unit include JP2014-240970A.

In addition, the polarizer may have non-polarizing parts arranged at predetermined intervals in the long-length direction and/or the width direction. The non-polarizing part is a decolorized part which is partially decolorized. The arrangement pattern of the non-polarizing parts can be appropriately set according to a purpose. For example, the non-polarizing parts are arranged at a position corresponding to a camera unit of an image display apparatus in a case where a polarizer is cut (cut, punched, or the like) to a predetermined size in order to be attached to the image display apparatus in a predetermined size. Examples of the arrangement pattern of the non-polarizing parts include those in JP2016-27392A.

### [Antireflection Layer]

The antireflection layer is not particularly limited, and a known antireflection layer can be used.

Examples of the antireflection layer include the antireflection layers described in paragraphs 0108 to 0121 of WO2016/047648A, the contents of which are incorporated in the present specification.

### [Retardation Layer]

The retardation layer is not particularly limited, and a known retardation layer can be used.

Examples of the retardation layer include a stretched polycarbonate film, a stretched norbornene-based polymer film, a transparent film containing aligned inorganic particles having birefringence, such as strontium carbonate, a thin film in which oblique deposition of an inorganic dielectric is performed on a support, a film in which the liquid crystal compound is uniaxially aligned and the alignment is fixed, and the like.

In addition, as the retardation layer, a film in which the above-described liquid crystal compound is uniaxially aligned and fixed is preferable.

### [Image Display Apparatus]

The image display apparatus according to the embodiment of the present invention has the laminate according to the embodiment of the present invention.

The display element used in the image display apparatus according to the embodiment of the present invention is not particularly limited, and examples thereof include a liquid crystal cell, an organic EL display panel, an inorganic EL display panel, and a plasma display panel.

### [Method for Manufacturing Laminate]

A method of manufacturing the laminate according to the embodiment of the present invention is not particularly limited.

Examples of the manufacturing method according to the first aspect include a method of manufacturing a laminate, the method including a light absorption anisotropic film forming step of forming a light absorption anisotropic film that is a film formed by immobilizing an alignment state of a liquid crystal composition containing a liquid crystal compound, a dichroic substance, and a compound having a thiol group, in which an angle θ between a transmittance central axis of the film and a normal direction of a surface of the film is 0° C. or more and 450 or less, on a temporary support; a transfer step of transferring the light absorption anisotropic film to a support and peeling off the temporary support after the light absorption anisotropic film forming step; and a molding step of pressing the light absorption anisotropic film against a mold having a curved surface portion after the transfer step to mold the curved surface portion in the light absorption anisotropic film.

That is, the manufacturing method according to the first aspect is a method of forming a curved surface portion in a light absorption anisotropic film by preparing a laminate having a support and a light absorption anisotropic film by a known method in the related art, using the liquid crystal composition containing the above-described thiol compound, and pressing the light absorption anisotropic film against a mold having a curved surface portion, except that the liquid crystal composition containing the above-described thiol compound is used.

In addition, examples of the manufacturing method according to the second aspect include a method of manufacturing a laminate, the method including a light absorption anisotropic film forming step of forming a light absorption anisotropic film that is a film formed by immobilizing an alignment state of a liquid crystal composition containing a liquid crystal compound, a dichroic substance, and a compound having a thiol group, in which an angle θ between a transmittance central axis of the film and a normal direction of a surface of the film is 0° C. or more and 45° or less, on a support having a curved surface portion.

That is, the manufacturing method according to the first aspect is the same as the known method in the related art (for example, the above-described coating film forming step and alignment step) except that the support having a curved surface portion is used and the liquid crystal composition containing the above-described thiol compound is used.

### [Optical Device/Head-Mounted Display]

The optical device according to the embodiment of the present invention is an optical device including the optical filter including the above-described laminate according to the embodiment of the present invention and a light guide plate in which a diffraction element is disposed on a surface.

In addition, the head-mounted display according to the embodiment of the present invention is a head-mounted display including the above-described optical device and an image display element.

### EXAMPLES

Hereinbelow, the present invention will be described in more detail with reference to Examples. The materials, the amounts of materials used, the ratios, the treatment details, the treatment procedure, or the like shown in the following Examples can be appropriately modified without departing from the spirit of the present invention. Therefore, the scope of the present invention should not be limitatively interpreted by the following examples.

### Example 1

### (1) Temporary Support

A surface of a cellulose acylate film 1 (TAC substrate having a thickness of 40 km; TG40 FUJIFILM Corporation) as a temporary support was saponified with an alkali solution and used.

### (2) Preparation of Alignment Film

The following composition 1 for forming an alignment film was applied to the cellulose acylate film 1. The temporary support on which the coating film was formed was dried with hot air at 145° C. for 120 seconds to form an alignment film 1. The film thickness of the alignment film 1 was 0.5 μm.

Composition 1 for Forming Alignment Film

| | |
|---|---|
| Polymer PA-1 shown below | 10.0 parts by mass |
| Acid generator PAG-1 shown below | 0.83 parts by mass |
| Stabilizer DIPEA shown below | 0.06 parts by mass |
| Butyl acetate | 100 parts by mass |

Polymer PA-1 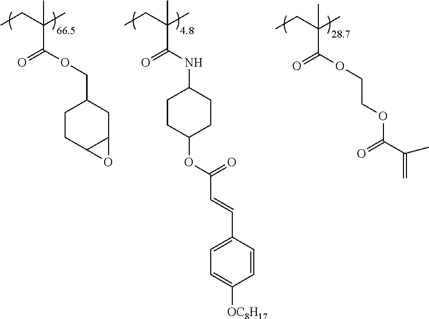
Acid generator PAG-1 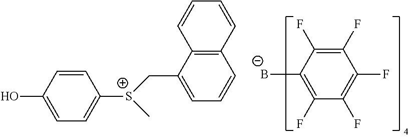
Stabilizer DIPEA

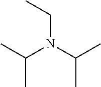

### (3) Production of Light Absorption Anisotropic Film

The composition 1 for forming a light absorption anisotropic film having the following composition was applied onto the obtained TAC (triacetyl cellulose) film with the alignment film using a wire bar, and heated at 120° C. for 60 seconds and cooled to 35° C. Next, the coating layer was heated at 75° C. for 60 seconds and cooled to room temperature again.

Thereafter, the film was irradiated with a light emitting diode (LED) lamp (central wavelength: 365 nm) for 2 seconds under an irradiation condition of an illuminance of 200 mW/cm² from the film normal direction under a nitrogen purge condition (oxygen concentration: 100 ppm or less), thereby producing a light absorption anisotropic film 1 on the alignment film. The film thickness of the light absorption anisotropic film 1 was 4.5 μm.

The transmittance central axis angle θ of the produced light absorption anisotropic layer 1 was measured by the above-described method. The results are listed in Table 1.

Composition for forming light absorption anisotropic film 1

| | |
|---|---|
| Dichroic substance D-1 shown below | 0.69 parts by mass |
| Dichroic substance D-2 shown below | 0.17 parts by mass |
| Dichroic substance D-3 shown below | 1.13 parts by mass |
| Polymer liquid crystal compound P-1 shown below | 8.67 parts by mass |
| Liquid crystal compound L-1 shown below | 1.97 parts by mass |
| IRGACURE OXE-2 (manufactured by BASF SE) | 0.20 parts by mass |
| Vertical alignment agent E-1 shown below | 0.16 parts by mass |
| Vertical alignment agent E-2 shown below | 0.16 parts by mass |
| Thiol compound (EHMP, manufactured by SC Organic Chemical Co., Ltd.) | 0.407 parts by mass |
| Surfactant F-1 shown below | 0.007 parts by mass |
| Cyclopentanone | 78.17 parts by mass |
| Benzyl alcohol | 8.69 parts by mass |

Dichroic Substance D-1 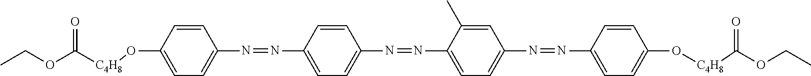
Dichroic Substance D-2 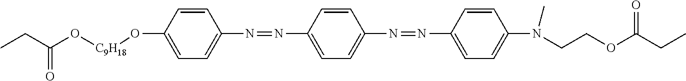
Dichroic Substance D-3 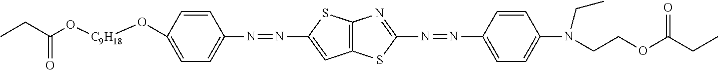
Polymer Liquid Crystal Compound P-1 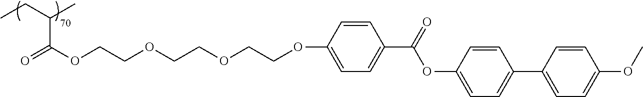 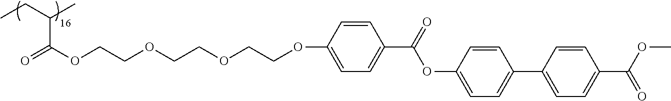 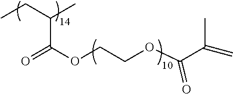
Liquid crystal compound L-1 [mixture of the following liquid crystal compounds (RA), (RB), and (RC) at a ratio of 84:14:2 (mass ratio)]
(RA) 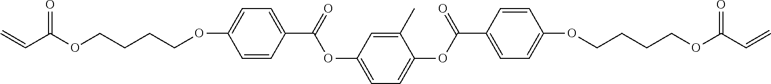 [SMILES: C=CC(=O)OCCCCOc1ccc(C(=O)Oc2ccc(OC(=O)c3ccc(OCCCCOC(=O)C=C)cc3)c(C)c2)cc1]
(RB) 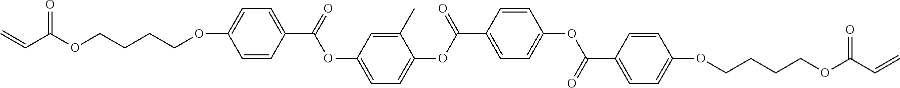 [SMILES: C=CC(=O)OCCCCOc1ccc(C(=O)Oc2ccc(C(=O)Oc3ccc(OC(=O)c4ccc(OCCCCOC(=O)C=C)cc4)cc3C)cc2)cc1]
(RC) 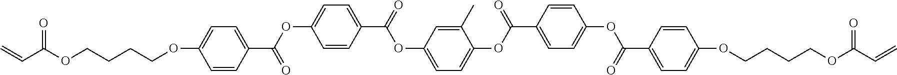 [SMILES: C=CC(=O)OCCCCOc1ccc(C(=O)Oc2ccc(C(=O)Oc3ccc(OC(=O)c4ccc(OC(=O)c5ccc(OCCCCOC(=O)C=C)cc5)cc4)c(C)c3)cc2)cc1]
Vertical Alignment Agent E-1 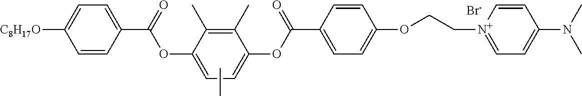
Vertical Alignment Agent E-2 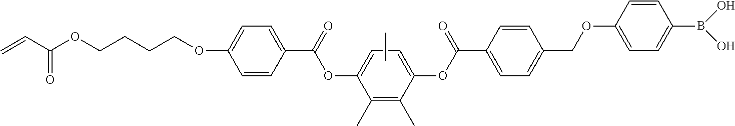
Surfactant F-1

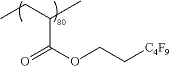

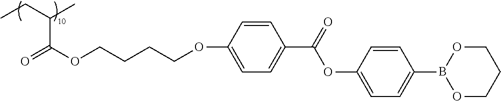

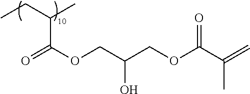

### (4) Preparation of Protective Layer

The surface of the obtained light absorption anisotropic film 1 was subjected to a corona treatment under conditions of 4.0 m/min, 440 W, and a clearance of 2.0 mm.

Next, a coating liquid 1 for forming a protective layer having the following composition was applied onto the light absorption anisotropic film 1 after the corona treatment with a wire bar to form a coating film.

Next, the temporary support on which the coating film was formed was dried with hot air at 60° C. for 60 seconds and further dried with hot air at 100° C. for 120 seconds to form a protective layer 1.

Thereafter, the light absorption anisotropic film 1 was irradiated with an LED lamp (central wavelength: 365 nm) for 2 seconds under an irradiation condition of an illuminance of 200 mW/cm² from the film normal direction under a nitrogen purge condition (oxygen concentration: 100 ppm or less), thereby forming the protective layer 1 on the light absorption anisotropic film 1 to produce a light absorption anisotropic film 1 (layer configuration: temporary support 1/alignment film 1/light absorption anisotropic film 1/protective layer 1). A film thickness of the protective layer 1 was 0.5 μm.

Coating liquid 1 for forming protective layer

| | |
|---|---|
| Modified polyvinyl alcohol PVA-1 shown below | 3.80 parts by mass |
| IRGACURE 2959 (manufactured by BASF SE) | 0.20 parts by mass |
| Coloring agent compound G-1 shown below | 0.08 parts by mass |
| Water | 70 parts by mass |
| Methanol | 30 parts by mass |

Modified Polyvinyl Alcohol PVA-1 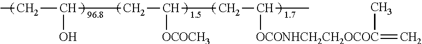
Coloring agent compound G-1

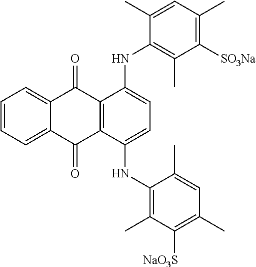

### (5) Curvature Processing of Light Absorption Anisotropic Film

The protective layer 1 side of the light absorption anisotropic film 1 (layer configuration: temporary support 1/alignment film 1/light absorption anisotropic film 1/protective layer 1) was bonded to a PMMA film through a pressure sensitive adhesive sheet, only the temporary support was peeled off, and the light absorption anisotropic film 2 was set in a forming device. At this time, the PMMA side was positioned on the upper side. The forming space in the forming device consists of a box 1 and a box 2 partitioned by the light absorption anisotropic film 2, and a mold having a three-dimensional curved surface at a corner portion and a developable surface having a rounded edge at an edge portion was produced to simulate a surface shape of a smartphone cover glass (size: 65 mm×140 mm, minimum curvature radius of three-dimensional curved surface of rounded edge portion: 38 mm, minimum curvature radius of developable surface of rounded edge portion: 38 mm) as a mold, and the mold was disposed such that the curved surface of the rounded edge portion was on the upper side in the box 1 below the light absorption anisotropic film 2.

In addition, in the box 2 on the upper side of the light absorption anisotropic film 2, an IR light source for heating the light absorption anisotropic film 2 was installed on the outside of a transparent window installed on the upper part.

Next, each of the inside of box 1 and the inside of box 2 was evacuated to 0.1 atm or less by a vacuum pump.

Next, as a step of heating the light absorption anisotropic film 2, the light absorption anisotropic film 2 was irradiated with infrared rays and heated until the temperature of the light absorption anisotropic film 2 reached 108° C.

Next, as a step of pressing the light absorption anisotropic film 2 against the mold to deform the light absorption anisotropic film 2 along the shape of the mold, the box 2 was pressurized to 300 kPa by allowing a gas to flow from a gas cylinder, and the light absorption anisotropic film 2 was press-fitted to the mold.

Next, the light absorption anisotropic film 2 was removed from the cover glass which was the mold.

As a result, a light absorption anisotropic film 2 having a curved surface portion was obtained.

### Example 2

A laminate 2 was produced in the same manner as in Example 1, except that the composition 1 for forming a light absorption anisotropic film was changed to a composition 2 for forming a light absorption anisotropic film having the following composition.

Composition for forming light absorption anisotropic film 2

| | | |
|---|---|---|
| Dichroic substance D-1 shown above | 0.69 | parts by mass |
| Dichroic substance D-2 shown above | 0.17 | parts by mass |
| Dichroic substance D-3 shown above | 1.13 | parts by mass |
| Polymer liquid crystal compound P-1 shown | 8.67 | parts by mass |
| above | | |
| Liquid crystal compound L-1 shown above | 1.97 | parts by mass |
| IRGACUE OXE-2 (manufactured by BASF SE) | 0.20 | parts by mass |
| Vertical alignment agent E-1 shown above | 0.16 | parts by mass |
| Vertical alignment agent E-2 shown above | 0.16 | parts by mass |
| Thiol compound (BMPA, manufactured by | 0.407 | parts by mass |
| SC Organic Chemical Co., Ltd.) | | |
| Surfactant F-1 shown above | 0.007 | parts by mass |
| Cyclopentanone | 78.17 | parts by mass |
| Benzyl alcohol | 8.69 | parts by mass |

### Example 3

A laminate 3 was produced in the same manner as in Example 1, except that the composition 1 for forming a light absorption anisotropic film was changed to a composition 3 for forming a light absorption anisotropic film having the following composition.

Composition for forming light absorption anisotropic film 3

| | | |
|---|---|---|
| Dichroic substance D-1 shown above | 0.69 | parts by mass |
| Dichroic substance D-2 shown above | 0.17 | parts by mass |
| Dichroic substance D-3 shown above | 1.13 | parts by mass |
| Polymer liquid crystal compound P-1 shown | 8.67 | parts by mass |
| above | | |
| Liquid crystal compound L-1 shown above | 1.97 | parts by mass |
| IRGACUE OXE-2 (manufactured by BASF SE) | 0.20 | parts by mass |
| Vertical alignment agent E-1 shown above | 0.16 | parts by mass |
| Vertical alignment agent E-2 shown above | 0.16 | parts by mass |
| Thiol compound (EGDMP, Anhui Royal | 0.407 | parts by mass |
| Chemical Co., Ltd.) | | |
| Surfactant F-1 shown above | 0.007 | parts by mass |
| Cyclopentanone | 78.17 | parts by mass |
| Benzyl alcohol | 8.69 | parts by mass |

### Example 4

A laminate 4 was produced in the same manner as in Example 1, except that the composition 1 for forming a light absorption anisotropic film was changed to a composition 4 for forming a light absorption anisotropic film having the following composition.

Composition for forming light absorption anisotropic film 4

| | | |
|---|---|---|
| Dichroic substance D-1 shown above | 0.69 | parts by mass |
| Dichroic substance D-2 shown above | 0.17 | parts by mass |
| Dichroic substance D-3 shown above | 1.13 | parts by mass |
| Polymer liquid crystal compound P-1 shown | 8.67 | parts by mass |
| above | | |
| Liquid crystal compound L-1 shown above | 1.97 | parts by mass |
| IRGACUE OXE-2 (manufactured by BASF SE) | 0.20 | parts by mass |
| Vertical alignment agent E-1 shown above | 0.16 | parts by mass |
| Vertical alignment agent E-2 shown above | 0.16 | parts by mass |
| Thiol compound (PEMP, manufactured by | 0.407 | parts by mass |
| SC Organic Chemical Co., Ltd.) | | |
| Surfactant F-1 shown above | 0.007 | parts by mass |
| Cyclopentanone | 78.17 | parts by mass |
| Benzyl alcohol | 8.69 | parts by mass |

### Example 5

A laminate 5 was produced in the same manner as in Example 1, except that the composition 1 for forming a light absorption anisotropic film was changed to a composition 5 for forming a light absorption anisotropic film having the following composition.

Composition for forming light absorption anisotropic film 5

| | | |
|---|---|---|
| Dichroic substance D-1 shown above | 0.69 | parts by mass |
| Dichroic substance D-2 shown above | 0.17 | parts by mass |
| Dichroic substance D-3 shown above | 1.13 | parts by mass |
| Polymer liquid crystal compound P-1 shown | 8.67 | parts by mass |
| above | | |
| Liquid crystal compound L-1 shown above | 1.97 | parts by mass |
| IRGACUE OXE-2 (manufactured by BASF SE) | 0.20 | parts by mass |
| Vertical alignment agent E-1 shown above | 0.16 | parts by mass |
| Vertical alignment agent E-2 shown above | 0.16 | parts by mass |
| Thiol compound (Karenz MT BD1, | 0.407 | parts by mass |
| manufactured by Resonac Corporation) | | |
| Surfactant F-1 shown above | 0.007 | parts by mass |
| Cyclopentanone | 78.17 | parts by mass |
| Benzyl alcohol | 8.69 | parts by mass |

### Example 6

A laminate 6 was produced in the same manner as in Example 1, except that the composition 1 for forming a light absorption anisotropic film was changed to a composition 6 for forming a light absorption anisotropic film having the following composition.

Composition for forming light absorption anisotropic film 6

| | | |
|---|---|---|
| Dichroic substance D-1 shown above | 0.69 | parts by mass |
| Dichroic substance D-2 shown above | 0.17 | parts by mass |
| Dichroic substance D-3 shown above | 1.13 | parts by mass |
| Polymer liquid crystal compound P-1 shown | 8.67 | parts by mass |
| above | | |
| Liquid crystal compound L-1 shown above | 1.97 | parts by mass |
| IRGACUE OXE-2 (manufactured by BASF SE) | 0.20 | parts by mass |
| Vertical alignment agent E-1 shown above | 0.16 | parts by mass |
| Vertical alignment agent E-2 shown above | 0.16 | parts by mass |
| Thiol compound (Karenz MT TPMB, | 0.407 | parts by mass |
| manufactured by Resonac Corporation) | | |
| Surfactant F-1 shown above | 0.007 | parts by mass |
| Cyclopentanone | 78.17 | parts by mass |
| Benzyl alcohol | 8.69 | parts by mass |

### Example 7

A laminate 7 was produced in the same manner as in Example 1, except that the composition 1 for forming a light absorption anisotropic film was changed to a composition 7 for forming a light absorption anisotropic film having the following composition.

Composition for forming light absorption anisotropic film 7

| | | |
|---|---|---|
| Dichroic substance D-1 shown above | 0.69 | parts by mass |
| Dichroic substance D-2 shown above | 0.17 | parts by mass |
| Dichroic substance D-3 shown above | 1.13 | parts by mass |
| Polymer liquid crystal compound P-1 shown | 8.67 | parts by mass |
| above | | |
| Liquid crystal compound L-1 shown above | 1.97 | parts by mass |
| IRGACUE OXE-2 (manufactured by BASF SE) | 0.20 | parts by mass |
| Vertical alignment agent E-1 shown above | 0.16 | parts by mass |
| Vertical alignment agent E-2 shown above | 0.16 | parts by mass |
| Thiol compound (Karenz MT TPMB, | 0.840 | parts by mass |
| manufactured by Resonac Corporation) | | |
| Surfactant F-1 shown above | 0.007 | parts by mass |
| Cyclopentanone | 78.17 | parts by mass |
| Benzyl alcohol | 8.69 | parts by mass |

### Example 8

A laminate 8 was produced in the same manner as in Example 7, except that the mold used for the curvature processing of the light absorption anisotropic film was changed to a concave lens (diameter: 50 nmφ, curvature radius: 52 mm).

### Example 9

The composition 1 for forming an alignment film of Example 1 was applied onto the surface of the concave lens (diameter: 50 nmφ, curvature radius: 52 mm) using a spin coater. After the application, the film was dried with hot air at 145° C. for 120 seconds to form an alignment film. The film thickness of the alignment film was 0.5 μm.

Next, the composition 7 for forming a light absorption anisotropic film of Example 7 was applied onto the formed alignment film using a spin coater, and heated at 120° C. for 60 seconds and cooled to 35° C. Next, the coating layer was heated at 75° C. for 60 seconds and cooled to room temperature again.

Thereafter, under a nitrogen purge condition (oxygen concentration: 100 ppm or less), the coating film was irradiated with light from the film normal direction for 2 seconds under an irradiation condition of an illuminance of 200 mW/cm² using an LED lamp (center wavelength: 365 nm) to prepare a light absorption anisotropic layer 1 on the alignment film. The film thickness of the light absorption anisotropic film 1 was 4.5 μm.

Next, the surface of the obtained light absorption anisotropic film was subjected to a corona treatment under conditions of 4.0 m/min, 440 W, and a clearance of 2.0 mm, and then the coating liquid 1 for forming a protective layer of Example 1 was applied using a spin coater.

Next, the support on which the coating film was formed was dried with hot air at 60° C. for 60 seconds and further dried with hot air at 100° C. for 120 seconds to form a protective layer.

Thereafter, the protective layer was formed by irradiating the film with an LED lamp (central wavelength: 365 nm) for 2 seconds under an irradiation condition of an illuminance of 200 mW/cm² from directly above under a nitrogen purge condition (oxygen concentration: 100 ppm or less), thereby producing a laminate. A film thickness of the protective layer was 0.5 μm.

By the above operation, a lens-shaped light absorption anisotropic film sample was produced.

### Example 10

A laminate 10 was produced in the same manner as in Example 1, except that the composition 1 for forming a light absorption anisotropic film was changed to a composition 10 for forming a light absorption anisotropic film having the following composition.

Composition for forming light absorption anisotropic film 10

| | |
|---|---|
| Dichroic substance D-4 shown below | 1.82 parts by mass |
| Dichroic substance D-5 shown below | 0.49 parts by mass |
| Dichroic substance D-6 shown below | 3.25 parts by mass |
| Polymer liquid crystal compound P-1 shown above | 18.21 parts by mass |
| Liquid crystal compound L-1 shown above | 4.13 parts by mass |
| IRGACURE 369 (manufactured by BASF SE) | 1.67 parts by mass |
| Vertical alignment agent E-1 shown above | 0.37 parts by mass |
| Vertical alignment agent E-2 shown above | 0.37 parts by mass |
| Thiol compound (Karenz MT TPMB, manufactured by Resonac Corporation) | 1.94 parts by mass |
| BYK-361N (manufactured by BYK-Chemie GmbH) | 0.084 parts by mass |
| o-xylene | 200 parts by mass |

Dichroic substance D-4 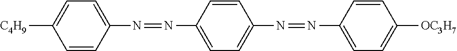
Dichroic Substance D-5 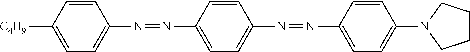
Dichroic Substance D-6

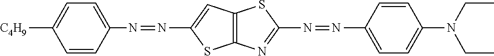

### Example 11

A laminate 11 was produced in the same manner as in Example 1, except that the composition 1 for forming a light absorption anisotropic film was changed to a composition 11 for forming a light absorption anisotropic film having the following composition.

Composition for forming light absorption anisotropic film 11

| | |
|---|---|
| Dichroic substance D-1 shown above | 0.79 parts by mass |
| Dichroic substance D-2 shown above | 0.21 parts by mass |
| Dichroic substance D-3 shown above | 1.41 parts by mass |
| Liquid crystal compound L-2 shown below | 7.52 parts by mass |
| Liquid crystal compound L-3 shown below | 2.51 parts by mass |
| IRGACURE 369 (manufactured by BASF SE) | 0.73 parts by mass |
| Thiol compound (Karenz MT TPMB, manufactured by Resonac Corporation) | 0.843 parts by mass |
| BYK-361N (manufactured by BYK-Chemie GmbH) | 0.036 parts by mass |
| Cyclopentanone | 78.13 parts by mass |
| Benzyl alcohol | 8.67 parts by mass |

Liquid crystal compound L-2 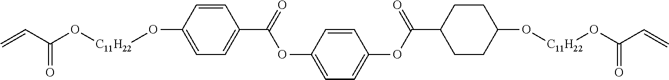
Liquid crystal compound L-3

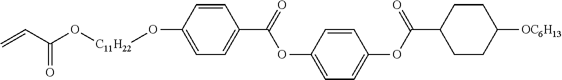

### Example 12

A laminate 12 was produced in the same manner as in Example 1, except that the composition 1 for forming a light absorption anisotropic film was changed to a composition 12 for forming a light absorption anisotropic film having the following composition.

Composition for forming light absorption anisotropic film 12

| | | |
|---|---|---|
| Dichroic substance D-4 shown above | 0.78 | parts by mass |
| Dichroic substance D-5 shown above | 0.21 | parts by mass |
| Dichroic substance D-6 shown above | 1.39 | parts by mass |
| Liquid crystal compound L-2 shown above | 7.39 | parts by mass |
| Liquid crystal compound L-3 shown above | 2.46 | parts by mass |
| IRGACUE 369 (manufactured by BASF SE) | 0.71 | parts by mass |
| Thiol compound (Karenz MT TPMB, | 0.828 | parts by mass |
| manufactured by Resonac Corporation) | | |
| BYK-361N (manufactured by BYK-Chemie | 0.036 | parts by mass |
| GmbH) | | |
| o-xylene | 87.02 | parts by mass |

### Comparative Example 1

A laminate H1 was produced in the same manner as in Example 1, except that the thiol compound was not blended in the composition 1 for forming a light absorption anisotropic film.

### [Evaluation]

For the produced laminate, the maximal absorption wavelength of the dichroic substance used, the content (mg/cm³) of the dichroic substance, and the alignment degree, the difference in alignment degree at each wavelength, and the haze value of the light absorption anisotropic film measured by the above-described method are shown in Table 1.

### [Variation in Film Thickness]

A cross-sectional view of the curved surface portion of the produced laminate was observed with a scanning electron microscope (SEM), the film thickness of the light absorption anisotropic film was measured at any five points, and the measurement was evaluated according to the following standard.

In Table 1, “developable surface” means “developable surface (edge portion) of rounded edge cover glass”, and “three-dimensional” means “corner portion” in the rounded edge cover glass and the entire surface of the concave lens is a three-dimensional curved surface.

### <Evaluation Standard>

A+: thickness unevenness was less than 4%
A: thickness unevenness was 4% or more and less than 5%
B: thickness unevenness was 5% or more and less than 6%
C: thickness unevenness was 6% or more and less than 10%
D: thickness unevenness was 10% or more

### [Cracks]

The curved surface portion of the produced laminate was observed with a 10× loupe, and the evaluation was performed according to the following standard in the light absorption anisotropic film having the curved surface portion.

### <Evaluation Standard>

A: cracks were not visible.
B: cracks were slightly visible.
C: cracks were clearly visible.

### [Preservation Property]

The viscosities of the compositions for forming a light absorption anisotropic film used in Examples 1 to 12 and Comparative Example 1 were measured, and the viscosities immediately after preparation of the solution and after being left at room temperature (23° C.) for 1 week were measured, and the measurement was evaluated according to the following standard.

### <Evaluation Standard>

A: viscosity increase was 5% or less
B: viscosity increase was more than 5% and 20% or less

TABLE 1

| | | Example 1 | | Example 2 | Example 3 | Example 4 | Example 5 | Example 6 | Example 7 |
|---|---|---|---|---|---|---|---|---|---|
| thiol group | type | primary | | primary | primary | primary | secondary | secondary | secondary |
| | functional | 1 | | 1 | 2 | 4 | 2 | 3 | 3 |
| | group | | | | | | | | |
| | number | | | | | | | | |
| | molecule | [symbol] | | [symbol] | EGDMP | PEMP | [symbol] | [symbol] | [symbol] |
| | structure | | | | | | | | |
| | additional | 3.0 | | 3.0 | 3.0 | 3.0 | 3.0 | 3.0 | 6.0 |
| | amount | | | | | | | | |
| | (% by mass) | | | | | | | | |
| | Mw | 218 | | 106 | 218 | [symbol] | 294 | 441 | 441 |
| | thiol | 218 | | 106 | 119 | 122 | 147 | 147 | 147 |
| | equivalent | | | | | | | | |
| formation | | formation method | | formation | formation | formation | formation | formation | formation |
| method | | | | method | method | method | method | method | method |
| curved | | rounded edge cover glass | | | | | | | |
| surface | curved | developable | three | three | three | three | three | three | three |
| shape | surface | surface | dimensional | dimensional | dimensional | dimensional | dimensional | dimensional | dimensional |
| | curvature | 38 mm | 38 mm | 38 mm | 38 mm | 38 mm | 38 mm | 38 mm | 38 mm |
| | radius | | | | | | | | |
| variation | curved | 6% | [symbol] | 7% | 5% | 4% | 5% | 4% | 3% |
| in film | surface | C | C | C | B | A | B | A | A+ |
| thickness | portion | | | | | | | | |
| Crack | curved | A | B | A | A | A | A | A | A |
| | surface | | | | | | | | |
| | portion | | | | | | | | |
| stability | | B | B | B | B | B | A | A | A |
| maximal | Y coloring | 415 | 415 | 415 | 415 | 415 | 415 | 415 | 415 |
| absorption | agent/nm | | | | | | | | |
| wavelength | M coloring | 455 | 455 | 455 | 455 | 455 | 455 | 455 | 455 |
| of dichroic | agent/nm | | | | | | | | |
| substance | C coloring | 612 | 612 | 612 | 612 | 612 | 612 | 612 | 612 |
| | agent/nm | | | | | | | | |
| content of | mg/cm³ | 199 | 199 | 199 | 199 | 199 | 199 | 199 | 198 |
| dichroic | | | | | | | | | |
| substance | | | | | | | | | |
| alignment | 530 nm | 0.930 | 0.930 | 0.930 | 0.940 | 0.950 | 0.950 | 0.950 | 0.950 |
| degree of light | | | | | | | | | |
| absorption | | | | | | | | | |
| anisotropic film | | | | | | | | | |
| difference in | (maximum | 0.040 | 0.040 | 0.040 | 0.033 | 0.030 | 0.025 | 0.020 | 0.020 |
| the alignment | value) | | | | | | | | |
| degree at each | | | | | | | | | |
| wavelength | | | | | | | | | |
| base value | | 0.31% | 0.51% | 0.51% | 0.50% | 0.40% | 0.31% | 0.30% | 0.25% |
| transmittance | | 0° | 0° | 0° | 0° | 0° | 0° | 0° | 0° |
| central axis | | | | | | | | | |
| angle A | | | | | | | | | |

| | | Example 8 | Example 9 | Example 10 | Example 11 | Example 12 | Comparative Example 1 | |
|---|---|---|---|---|---|---|---|---|
| thiol group | type | secondary | secondary | secondary | secondary | secondary | none | |
| | functional | 3 | 3 | 3 | 3 | 3 | | |
| | group | | | | | | | |
| | number | | | | | | | |
| | molecule | [symbol] | [symbol] | [symbol] | [symbol] | [symbol] | | |
| | structure | | | | | | | |
| | additional | 6.0 | 6.0 | 6.0 | 6.0 | 6.0 | | |
| | amount | | | | | | | |
| | (% by mass) | | | | | | | |
| | Mw | 441 | 441 | 441 | 441 | 441 | | |
| | thiol | 147 | 147 | 147 | 147 | 147 | | |
| | equivalent | | | | | | | |
| formation | | formation | formation | formation | formation | formation | formation method | |
| method | | method | method | method | method | method | | |
| curved | | concave lens | | rounded edge cover glass | | | | |
| surface | curved | three | three | three | three | three | developable | three |
| shape | surface | dimensional | dimensional | dimensional | dimensional | dimensional | surface | dimensional |
| | curvature | 52 mm | 52 mm | 38 mm | 38 mm | 38 mm | 38 mm | 38 mm |
| | radius | | | | | | | |
| variation | curved | 3% | 5% | 5% | 5% | 5% | 10% | 12% |
| in film | surface | A+ | B | B | B | B | D | D |
| thickness | portion | | | | | | | |
| Crack | curved | A | A | A | A | A | C | C |
| | surface | | | | | | | |
| | portion | | | | | | | |
| stability | | A | A | A | A | A | A | A |
| maximal | Y coloring | 415 | 415 | 400 | 415 | 400 | 415 | 415 |
| absorption | agent/nm | | | | | | | |
| wavelength | M coloring | 455 | 455 | 500 | 455 | 500 | 455 | 455 |
| of dichroic | agent/nm | | | | | | | |
| substance | C coloring | 612 | 612 | 590 | 612 | 590 | 612 | 612 |
| | agent/nm | | | | | | | |
| content of | mg/cm³ | 198 | 198 | 240 | 240 | 237 | 199 | 199 |
| dichroic | | | | | | | | |
| substance | | | | | | | | |
| alignment | 530 nm | 0.950 | 0.950 | 0.950 | 0.950 | 0.950 | 0.910 | 0.910 |
| degree of light | | | | | | | | |
| absorption | | | | | | | | |
| anisotropic film | | | | | | | | |
| difference in | (maximum | 0.020 | 0.020 | 0.020 | 0.020 | 0.020 | 0.050 | 0.050 |
| the alignment | value) | | | | | | | |
| degree at each | | | | | | | | |
| wavelength | | | | | | | | |
| base value | | 0.25% | 0.25% | 0.25% | 0.25% | 0.25% | 0.30% | [symbol] |
| transmittance | | 0° | 0° | 0° | 0° | 0° | 0° | 0° |
| central axis | | | | | | | | |
| angle A | | | | | | | | |

[symbol]

indicates data missing or illegible when filed

From the results shown in Table 1, it was found that, in a case where the thiol compound was not blended in the composition for forming a light absorption anisotropic film (liquid crystal composition), the variation in film thickness occurred in the curved surface portion of the light absorption anisotropic film, and cracks also occurred (Comparative Example 1).

On the other hand, it was found that, in a case where the thiol compound was blended in the composition for forming a light absorption anisotropic film (liquid crystal composition), the occurrence of the variation in film thickness and the cracks in the curved surface portion of the light absorption anisotropic film was suppressed (Examples 1 to 12).

In particular, from the comparison of Examples 1 to 4, it was found that, in a case where the thiol compound had two or more primary or secondary thiol groups in one molecule, the occurrence of the variation in film thickness and the cracks in the curved surface portion was further suppressed.

From the comparison of Examples 3 and 5, it was found that, in a case where at least one of the thiol groups of the thiol compound was a secondary thiol group, the storage stability of the liquid crystal composition was improved.

From the comparison of Examples 1 and 2, it was found that, in a case where the thiol equivalent of the thiol compound was 200 or less, the occurrence of the cracks and the variation in film thickness of the curved surface portion (particularly, the three-dimensional curved surface) was further suppressed.

From the comparison of Examples 6 and 7, it was found that, in a case where the content of the thiol group compound was 5% to 15% by mass with respect to the total mass of the light absorption anisotropic film, the occurrence of the variation in film thickness and the cracks was further suppressed, and the alignment degree of the dichroic coloring agent could be maintained high.

### EXPLANATION OF REFERENCES

10: light absorption anisotropic film

What is claimed is:

1. A light absorption anisotropic film having a curved surface portion,
wherein the light absorption anisotropic film is a film obtained by fixing an alignment state of a liquid crystal composition containing a liquid crystal compound, a dichroic substance, and a compound having a thiol group, and
an angle θ between a transmittance central axis of the light absorption anisotropic film and a normal direction of a surface of the light absorption anisotropic film is 0° or more and 45° or less.

2. The light absorption anisotropic film according to claim 1,
wherein the compound having the thiol group is a compound having 2 or more primary or secondary thiol groups in one molecule.

3. The light absorption anisotropic film according to claim 2,
wherein at least one of the thiol groups is the secondary thiol group.

4. The light absorption anisotropic film according to claim 1,
wherein a thiol equivalent of the compound having the thiol group is 200 or less.

5. The light absorption anisotropic film according to claim 1,
wherein a content of the compound having the thiol group is 5% to 15% by mass with respect to a total mass of the light absorption anisotropic film.

6. The light absorption anisotropic film according to claim 1,
wherein a curved surface shape in the curved surface portion is lens-shaped.

7. The light absorption anisotropic film according to claim 1,
wherein a minimum curvature radius in the curved surface portion is 20 to 300 mm.

8. The light absorption anisotropic film according to claim 1,
wherein the dichroic substance is a mixture containing at least a coloring agent compound having a maximal absorption wavelength in a wavelength range of 380 nm or more and less than 455 nm, a coloring agent compound having a maximal absorption wavelength in a wavelength range of 455 nm or more and less than 560 nm, and a coloring agent compound having a maximal absorption wavelength in a wavelength range of 560 nm or more and 700 nm or less.

9. The light absorption anisotropic film according to claim 1,
wherein a content of the dichroic substance contained in the light absorption anisotropic film is 20 to 650 mg/cm³.

10. The light absorption anisotropic film according to claim 1,
wherein an alignment degree of the light absorption anisotropic film at a wavelength of 550 nm is 0.94 or more.

11. The light absorption anisotropic film according to claim 1,
wherein a difference in alignment degree of the light absorption anisotropic film at wavelengths of 450 nm, 550 nm, and 650 nm is 0.025 or less.

12. The light absorption anisotropic film according to claim 1,
wherein a haze value of the light absorption anisotropic film is 0.3% or less.

13. A laminate comprising:
the light absorption anisotropic film according to claim 1.

14. An optical device comprising:
the light absorption anisotropic film according to claim 1, and a light guide plate in which a diffraction element is disposed on a surface.

15. A head-mounted display comprising:
the optical device according to claim 14, and an image display element.

16. The light absorption anisotropic film according to claim 2,
wherein a thiol equivalent of the compound having the thiol group is 200 or less.

17. The light absorption anisotropic film according to claim 2,
wherein a content of the compound having the thiol group is 5% to 15% by mass with respect to a total mass of the light absorption anisotropic film.

18. The light absorption anisotropic film according to claim 2,
wherein a curved surface shape in the curved surface portion is lens-shaped.

19. The light absorption anisotropic film according to claim 2,
wherein a minimum curvature radius in the curved surface portion is 20 to 300 mm.

20. The light absorption anisotropic film according to claim 2,
wherein the dichroic substance is a mixture containing at least a coloring agent compound having a maximal absorption wavelength in a wavelength range of 380 nm or more and less than 455 nm, a coloring agent compound having a maximal absorption wavelength in a wavelength range of 455 nm or more and less than 560 nm, and a coloring agent compound having a maximal absorption wavelength in a wavelength range of 560 nm or more and 700 nm or less.
